(19) United States
(12) Patent Application Publication
(10) Pub. No.: US 2005/0197952 A1
(43) Pub. Date: Sep. 8, 2005

(54) Risk mitigation management

(75) Inventors: Edward Shea, Nalick, MA (US); David Stone, Charlotte, NC (US); Ed Baechtold, Goffstown, NH (US); Ralf Haug, Largo, FL (US); Andy Evans, Baltimore, MD (US)

Correspondence Address: MILES & STOCKBRIDGE PC, 1751 PINNACLE DRIVE, SUITE 500, MCLEAN, VA, 22102-3833, US

(73) Assignee: Providus Software Solutions, Inc., Nashua, NH (US)

(21) Appl. No.: 10/917,368

(22) Filed: Aug. 13, 2004

Related U.S. Application Data
(60) Provisional application No. 60/495,087, filed on Aug. 15, 2003.

(51) Int. Cl. G06F 17/60

(52) U.S. Cl. 705/38

(57) ABSTRACT

Risk mitigation and management is provided through an executive management application for the active management of operational risks, derived from exposure to factors that threaten strategic objectives related to operations, strategy, regulation and recording priorities. This system is based on a architecture that automates the Committee Of Sponsoring Organizations (COSO) framework for enterprise risk management, using the objective, risk, control and actions (ORCA) methodology to actively manage risk at the business unit level. This business process and feedback mechanism actively isolates, evaluates and escalates risks and controls in an interactive, proactive and dynamic manor. Workflow, alerts, messaging and roles and permission profiles route risk information to all relevant entities to ensure enterprise-wide visibility of, for example, a companies overall risk exposure.

### RELATED APPLICATION DATA

This application claims the benefit of and priority under 35 U.S.C. §119(e) to U.S. Patent Application No. 60/495,087, filed Aug. 15, 2003, entitled “Method and System for Managing Risk,” which is incorporated herein by reference in its entirety.

### BACKGROUND

1. Field of the Invention

This invention relates to risks. In particular, an exemplary aspect of this invention relates to risk mitigation and risk management in a business environment.

2. Description of Related Art

Businesses are subject to a variety of risks intrinsic to their operations and must categorize and manage these through a comprehensive and fully consistent framework. This framework should be calibrated to the nature of the risks and the institutional framework within which these risks are managed.

The practice of enterprise risk management is derived form a process whereby enterprise objectives are formulated and deployed throughout the business unit hierarchy and line business managers interpret these objectives in the context of their business operations. Managers are encouraged to align these institutional objectives with their operating mandate in day-to-day operations.

### SUMMARY

Most systems and processes developed to achieve this alignment fail however due to their own weight, or by the failure to integrate various risks tools, such as risk assessment metrics, key risk and performance indicators, contextual operational lost data, project management and work load capabilities, and local document repositories to guide line management. Senior executives, tasked with monitoring on-going risk exposures, fail to comprehend changing risk factors due to the general lack of consistent risk measures aggregated across all business units and sorted by key regulatory, legal, operational and strategic drivers. The most recent Basel II Accords and the Sarbanes-Oxley Act have increased industry attention to developing systems that encompass all of these features. To address these enterprise risk management objectives requires a widely deployable, scalable and easy-to-use system that enables, for example, business managers to interpret regulatory, operational and strategic objectives developed by senior executives in the government structure of the enterprise in the context of their day-to-day operations, and to assess risks, establish controls and signal to management inconsistent threat assessment and related action plans.

An exemplary aspect of the invention is directed toward providing the above-mentioned functionality needed to assess risk at the enterprise level, and to align risk assessments with business objectives, related regulatory and other drivers, while still integrating risk assessment and analysis into day-to-day operations at the business unit level. The risk information can then be driven, in real-time, to all relevant executives tasked with setting enterprise-level policies and corporate actions.

The Basel Committee on Bank Supervision states that operational risk is the science of mitigating the effects of loss events that are the result of errors due to people, processes and due to external events.

Operational risk management includes the processes of risk control self-assessment, scenario analysis, loss data capture and analysis and advanced analytical capital modeling. An exemplary aspect of this invention utilizes technological componentry to model the interaction between these four components of operational risk management.

More particularly, exemplary aspects of the invention are directed toward satisfying the Basel committee's formulation of a new capital standard for financial institutions. The standard is interwoven with best practices around corporate governance, policy and control in order to manage risk. The technological componentry discussed above integrates qualitative information gleaned from risk control self-assessment with internal and external experiences related to operational loss. Scenario analysis blends loss experiences and internal ratings of risk derived from the risk control self assessment process and is used to statistically condition the moments associated with estimated loss probabilities and their statistical distribution that is used to simulate values at risk and an appropriate regulatory capital level. The system is further enhanced through the weighing of past with present estimates of vulnerabilities within a controlled environment through the management, evaluation and scoring of risk profiles in an effort to mitigate losses.

Regulations such as Sarbanes-Oxley and the Basel II Accord are driving the stringent focus on assurances that risk-related processes take place with certainty and efficiency. For large financial institutions with complex organizational structures, these processes can number in the hundreds or thousands. This means institutions should establish an effective way to exercise control over large, complex sets of processes, while maintaining certainty and complete compliance with applicable law both horizontally and vertically.

Due to the broad and all-encompassing nature of these regulatory challenges, a solution is needed that can meet complex compliance while instilling rational risk management practices across the enterprise. Most CEOs, CFOs, boards of directors and audit committees view their operations as being held to a new higher standard of accountability. Increasing the metric by which they gauge this challenge is the volatility of their stock price and the associated vulnerability of their market capitalization. Thus, the heightened urgency of compliance is bringing with it a renewed focus by top management on the importance of managing multiple risks and on the need for controls to mitigate those risks.

Entities such as financial institutions, corporations, and other risk-based enterprises have a history of fragmented risk management processes. Typically these efforts have been compartmentalized and treated as separate functions, rather than as a unified risk and compliance effort throughout the organization. This appointed approach can result in redundancies and blind spots in the collective corporate oversight process with the result being that even financial institutions that have traditionally maintained very sophisticated operations to manage market and credit exposures have been surprised to find out that they were essentially blind to many “operational” business risks that could affect their market valuation.

Active risk management offers entities the opportunity to deploy a software solution from which they can manage all types of business risks to achieve multiple, parallel compliance objectives. Active risk management builds on the core discipline of operational risk management, and unlike other systems that are siloed or regulation-specific, is capable of providing a single information repository from which real-time, risk-informed decision-making can be made across and throughout the enterprise. This exemplary solution also provides an environment that documents enterprise-wide actions to abide by corporate governance and risk management policies.

A risk management framework supports the speedy deployment of financial and operational control at the business unit level and enables a management culture, where managers at every level, understand their responsibilities and more importantly become active and proactive managers of business risks. As a result, it is not necessary to rely on a compartmentalized dedicated staff for risk management but rather entities can leverage the business acumen of line managers and empower them to take action on risk management, both individually and collaboratively.

In an effort to integrate current standards, exemplary aspects of this system also supports best-practices methodology, such as the COSO ERM, by providing the enabling technology to embed corporate government policies into business operations. This approach will allow an unprecedented 360° real-time dynamic view of business risks and the efficacy of on-going internal risk controls so that managers can proactively mitigate or even prevent loss occurring events.

Financial institutions, in their own right, face unique challenges by virtue of their complexity and broad exposure to a variety of market and operational risks. Increasingly, institutions are recognizing that “linear” or problem-specific approaches to managing risk in a direct and quantitative way may mask underlying operational risks that can have a negative impact on performance. The best protection against these risks are operating controls that address business process related to compliance, people, systems and threats, both from inside and outside of the institution. Often the information needed to monitor these risks is qualitative and best measured at the point of vulnerability, such as the operational business unit or process.

An exemplary aspect of this invention enables line managers to identify these business risks in a manner that can be measured constantly across the enterprise, and to formulate mitigation plans and controls to lessen these risks. To further strengthen the management control environment, these activities are logged, reported and can be approved, rejected, modified, or the like, by one or more supervisors and/or peers. Risk control self assessment allows, for example, business units to analyze their business processes in a step-by-step manner to identify the strengths and weaknesses of their risk control program. The risk control self-assessment process does help, for example, to identify control gaps and risks. An active risk management framework enhances the risk control self-assessment process with formal assurance oversight procedures for risk identification, establishment of controls and the assignment of responsibilities. This two-pronged approach ensures, for example, the internal control processes and the associated risks are managed in a calibrated, systematic manner. Furthermore, these system-wide efforts are capable of being captured in a secure workspace that can be monitored by risk management committees and internal auditors and, for example, demonstrated and overseen by external reviewers and/or regulators.

Active risk management also allows continuous operational risk management that aligns risks to corporate objectives and encourages managers to establish controls and measure their effectiveness constantly. By automating these risk management practices supervisors can leverage information into an enterprising-wide early warning system. By taking this consolidated view of enterprise-wide risk exposure made possible through the exemplary systems and methods of this invention and taking into account major institutional objectives in the areas of operations, regulations, strategy, governance and financial reporting, the system is capable of providing clear evidence of success or failure in meeting these objectives.

The exemplary framework allows the management of multiple compliance and risk management objectives, given the realities of overlapping regulations within the industry, and the need to support risk and material events in Security Exchange Commission (SEC) filings. The framework can be configured to be compliant with all the major strategic and compliance objectives such as Sarbanes-Oxley, FDICIA, Basel II, Gramm-Leach Bliley, the USA Patriot Act, AML, and the like, as well as any other domestic or international regulations all within the single system.

Through the use of proactive monitoring of imminent risks and risk thresholds across an institution, an early warning system can be provided. Critical issues can be escalated and users notified based on business rules, management roles, corporate responsibilities, and the like. Dynamic alerts and action tracking capabilities can notify managers of changes in risk ratings and actions that are past due, making it easy to compare exposures, strengths and controls, and to address overdue actions. Exception reporting can be forwarded to an “early warning console,” with appropriate color-coded alerts to indicate, for example, status, and to promote problem identification and resolution such that managers can act in real-time to curb unacceptable risks and minimize financial losses and exposure.

By linking reporting to actions within risk management, auditing is simpler, and the system can assist managers in identifying and eliminating gaps in an institution's control environment.

Since financial institutions are organized both hierarchically and by major business sectors, process managers at all levels must be able to look at the activities throughout the business, by both vertically drilling down into information on key risk indicators, or horizontally across organizational and procedural boundaries. In effect, many custom views of aggregation and reporting may be necessary based on any number of filters, such as financial controls, financial statement line items, or various categories of the activities being managed. This complexity may require expeditious roll-up of the risk to the top of the organization, while preserving the ability of managers at every level to drill down into risk details according to there respective duties and assigned actions.

Since all line managers will become increasingly involved with risk management activities, an exemplary aspect of this invention allows managers to perform these functions easily and securely. Managers can have the ability to enter, view, track and report on risks and risk-related data customized for their individual areas of responsibility. Since the needs of the enterprise are best supported by the system with a transparent, rules-based workflow and role-specific permissions capabilities, the risks and actions are tied to these features to encourage and enforce institutional risk tolerances. This also allows and supports managers at every level by personalizing their individual business risk responsibilities within a framework that meets institutional information needs.

Another aspect of the present invention is the ability of internal auditors to be tasked with providing independent oversight of risk management processes and controls according to well-defined controls theory, practice and tradition. Proliferating regulatory requirements to test or certify controls across a broad range of activities have raised the need for external audit reviews of control environments as an expedient means of achieving compliance. An exemplary aspect of this invention allows this goal to be met and as a result produces a growing requirement that compliance activities occur in an enterprise-wide context and that the system captures them, while allowing internal auditors to oversee these activities and to document there own requirements. Thus, internal auditors can be given a method of interacting with business managers throughout the organization, the ability to comment on the efficacy and significance of internal controls, to conduct and document their own control test(s), and to track all the issues they flag within the system.

The annual output of the comprehensive control system and procedures can also be documented and stored for subsequent external review by, for example, the institution's regulatory compliance program.

As discussed in more detail below, risk control self assessment is a process by which individual business units in an institution analyze their business processes in a step-by-step manner to identify the strengths and weaknesses of their risk control programs. The risk control self-assessment process helps to identify risks and control gaps within an institution. This can be achieved, for example, with formal assurance and oversight processes to guarantee the controls are properly framed and functioning, and that responsibilities for these controls are understood. This allows internal controls, process and the associated risks to be managed in a calibrated, systematic manner. Furthermore, by utilizing the risk control self assessment processes in a system-wide manner, the efforts of various entities can be captured in a secure work space that can be monitored, for example, by internal audits and the risk management and audit committees, and then, for example, demonstrated to external regulators or reviewers. An exemplary embodiment of the invention supports seven steps in the risk-control self-assessment process: documentation, assessment, scoring, escalation, testing, oversight and certification. Through the incorporation of business process management, workflow, rules-based policy and role-based permission features, each of these steps can be uniquely supported.

Documentation provides the where, when and how in the context of the inventive control environment. The system allows the attachment of documents at any point throughout the ORCA (objective-risk-control-action) cycle. For example, the system allows the appropriate level of documentation to be associated with the defining of a risk, or defining the controls around that risk. In addition, the system supports individual documentation for each level of the control(s), if needed, or documentation at the individual action level. This document handling can be stored and managed internally by the system, or, for example, integrated with the use of a third-party document management system.

Assessment involves assessing risks as they impact the institution in a variety of different ways, and making judgments about how to define and handle the risks. COSO requires that you define a risk, assess it, categorize it and make a judgment as to whether the risk is acceptable or not. To achieve these objectives, the system allows the relating a risk to an objective, defining the risk precisely, assigning a flexible classification scheme to the risk to by a variety of dimensions that reflect, for example, an institution's culture, work methodology and regulatory requirements.

The classification of risks provides visibility into the nature of an institution's risk in different ways, which can include assigning a risk to a process or sub-process within the organization. Multiple opportunities for defining critical processes within a flexible classification can include, for example, ORM, financial assertions, business continuity planning, governance, and relevance compliance and initiatives. In addition, institutions can add as many additional criteria as necessary. The system also allows the assignment of a risk to be given a line item on a balance sheet or income statement, or to major risk-assessment factors, such as operational risk, credit, currency translation, liquidity, market, legal and regulatory and possibly several other types of risk, as appropriate, within the institutions business environment. This flexible classification scheme allows, for example, institutions to accurately model their own unique business traditions, even as responsibilities change, and provides reporting needs to ensure added value.

Once a risk is defined accurately in accordance with an institution's policies, the opportunities for scoring, rating or measuring the exposure associated with that risk are endless. These measures can be conditioned by probability measure or indices to provide expected losses related to a given event. Within a risk, users can be encouraged to determine whether the exposure trend is increasing or decreasing, based upon a management assessment of the institution's changing exposure.

The controls can be anything put into place in order to mitigate a risk. Institutions need the ability to score an individual control, and to identify that control by broad definitional control categories that can be reported on within the system. Generally, institutions break down these controls based on people, processes, systems and suppliers as well as a variety of other categories unique to the institution. Managers are typically free to define multiple controls within a given category and these can include checking procedures for various transactions, notifications or disclosure requirements, or various types of authorizations in addition to control environment variables.

Managers are encouraged to review these controls periodically, not merely as abstract exercises, but as a necessary precaution given the constantly changing business environment. Through this periodic review, a managers' approach is active and provides the ability to regulate exposures more closely. Managers' are responsible for the risks and controls, and their supervisors, if appropriate, are alerted to significant changes in operating conditions. With the sum total of all these influences, managers are asked to ascertain whether the control environment is still affective. These control-effectiveness ratings are often included in a “net exposure” calculation when combined with the inherent exposure derived from the risk rating process. This scoring methodology is completely flexible thus allowing more complex institutions the freedom to apply even more complex weighing factors to their exposures in order to accurately reflect their risk and control environment and to develop scenario analysis to project expected year-over-year losses.

Risk escalation has two components, each invoked by a different occurrence. In the first instance, whenever a manager rates a control as ineffective, risk escalation can trigger a series of workflows requiring a responsible manager to create an action plan, either by creating a new control or improving upon an existing control. Escalation then continues until the problem is resolved. In the second instance, internal audit staff may test a control, and if it is found to be ineffective, create an issue that is transferred to the manager of that control. The manager can then raise an action item that triggers a series of workflows until the issue is resolved. These escalation steps can be very regimented by virtue of the responsibility and accountability layers included within the overall system's workflows and all escalated items, required action items, and associated due dates, if any, can be logged within the system. The system can also assign one or more due dates for the responsible parties to take an action and is capable of tracking the on-going status until an issue is resolved. All of this can be comprehensively audit-trailed and logged within the system.

Management can be provided with, for example, a separate logon for testing controls. Control Testers can search and view any risk or control according to their privileges. When the testers select a risk and related controls, they can be presented with a read-only view that prevents them from modifying the control. Using proper business rules for the associated business unit, guidance from internal audit and/or prudent business judgment, the tester can assess the effectiveness of the internal control and document how the effectiveness was tested. Furthermore, comments and/or notations can be associated with the testing of the control and once completed a certification screen presented for the tester to attest to the control testing. As with the other aspects of the invention, a workspace can be provided that allows documenting the actions taken, attaching documents, if needed, and making available the record of all activities.

Oversight includes some of the same control testing activities as in the testing step, but includes oversight. The tester is a member of, for example, an internal audit staff, or some other oversight group, and is performing an audit of the control testing. The oversight step offers a second formal layer of control oversight. Additional functionality can be provided with this step, allowing, for example, the testing of and control over any risk, the performance of multiple tests against controls, and documentation of those tests, including attachments for, and comments on the effectiveness of controls. Testers can raise an issue within the system that triggers a workflow to the managers of the control notifying them that internal audit has flagged an issue. Upon notification, the system can assign a due date for resolution and possible recommendations for a course of action to take in response. The manager may then, for example, take an action or delegate a task to resolve it, and once resolved document the resolution in the system, which in turn can notify internal audit of the outcome. Again, throughout the entire process, all actions by all parties can be stored as a matter of record within the system, and those records can be viewed by, for example, external auditors in the form of control test detail reports.

Certification is part of management testing as well as the internal audit testing. For example, under Sarbanes-Oxley, on a quarterly basis management must attest that their controls are effective. This can only happen if all significant controls have been tested on a quarterly basis and the results of the test are rolled-up to the executive responsible for formal certification. This certification literally means that there have been no significant changes in the control environment.

Exemplary aspects of the system allow implication of the certification process, by tracking certifications at the individual control level and supporting multi-level certifications from the control owner all the way up to higher-level management. Furthermore, a tamper-proof audit trail can be provided for all certification activities that allows quicker and easier role-up certification reports to be generated for management, either on a periodic or ad hoc basis.

These and other features and advantages of this invention are described in, or are apparent from, the following detailed description of the embodiments.

### BRIEF DESCRIPTION OF THE DRAWINGS

The embodiment of this invention will be described in detail, with reference to the following figures, wherein:

FIG. 1 illustrates an exemplary embodiment of the risk management and mitigation system according to this invention;

FIG. 2 illustrates in greater detail an exemplary embodiment of the administration module according to this invention;

FIG. 3 illustrates in greater detail an exemplary embodiment of the risk control self assessment module according to this invention;

FIG. 4 is a flowchart illustrating an exemplary setup of the system according to this invention;

FIG. 5 is a flowchart illustrating an exemplary risk entry method according to this invention;

FIG. 6 is a flowchart illustrating an exemplary method for assigning classifications to a risk according to this invention;

FIG. 7 is a flowchart illustrating an exemplary method showing the workflow of a risk according to this invention;

FIG. 8 is a flowchart illustrating an exemplary method of handling a delete risk request according to this invention;

FIG. 9 is a flowchart illustrating an exemplary method of handling an action according to this invention;

FIG. 10 is a continuation of the last action determination from FIG. 9;

FIG. 11 illustrates exemplary messages and actions according to this invention; and

FIGS. 12-38 illustrate exemplary screen shots associated with exemplary embodiments of this invention.

### DETAILED DESCRIPTION

The exemplary systems and methods of this invention will be described in relation to risk mitigation and management. However, to avoid unnecessarily obscuring the present invention, the following description will omit well-known structures and devices that may be shown in block diagram form or otherwise summarized. For the purposes of explanation, numerous specific details are set forth in order to provide a thorough understanding of the present invention. It should however be appreciated that the present invention may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a LAN and/or the Internet, or within a dedicated risk mitigation and management system. Thus, it should be appreciated that the components of the risk mitigation and management system can be combined into one or more devices or collocated on a particular node of a distributed network, such as a communications network. It will be appreciated from the following description, and for reasons of computational efficiency, that the components of the risk mitigation and management system can be arranged at any location within a distributed network without affecting the operation of the system.

Furthermore, it should be appreciated that the various links connecting the elements can be wired or wireless links, or any combination thereof, or any other known or later developed element(s) that is capable of supplying and/or communicating data to and from the connected elements. Additionally, the term module as used herein can refer to any known or later developed hardware, software or combination of hardware and software that is capable of performing the functionality associated with that element.

The risk management mitigation system 100 comprises a risk control self assessment module 200, an administration module 300, a workflow module 400, a history module 500, a reporting module 600, a database 800, a user interface module 900, an alert module 1000 and an audit module 1200. The risk management and mitigation system 100 can also be connected, via link 5, to one or more networks 10, such as a distributed network, which can then be connected to one or more additional risk management and mitigation systems, not shown.

To setup the system, which provides the framework to accurately catalog, assess, score and act upon a risk, as well as the associated infrastructure regarding the hierarchical tree of responsibilities within an organization, policies and objectives are established that may be, for example, in accordance with COSO objectives regarding regulation, strategy, reporting and operations. These objectives and policies can be rule based and, as will be discussed hereinafter, have the capability of regulating and ensuring consistent handling of all aspects of risk management and mitigation. In conjunction with the establishment of these policies and objectives, an organizational tree, and users associated with each level of the organizational tree, are input into the system with the cooperation of the administration module 300 and rights assigned either on an individual or group basis to one or more of the users within the organization. As will become apparent hereinafter, these rights can govern such items as whether the user is actually able to create a new risk, edit the risk, modify the risk, delete the risk, approve an action, or the like. In general, the rights associated with one or more employees or groups of employees can be managed by the administration module 300 to control particular entities, or group activities within the risk management and mitigation system 100.

Additionally, the administration module 300 is in control of creating and maintaining one or more aspects of the system. These aspects pertain to such items such as “accurate financial reporting for investment portfolio,” or the like. Upon establishment of this basic workflow framework, users can commence entry of risks and the association of various controls, actions and scoring associated with those risks to allow the real-time dynamic monitoring of risks within an organization. It should be appreciated, that this organization can be an entity, such as a company, can include multiple entities, portions within an entity, such as a subgroup within a corporation, as well be national and/or multinational in nature and can extend to any individual, entity or group that has a need for risk management and mitigation.

In general, various elements within the risk management and mitigation system 100 cooperate to provide a comprehensive-real-time dynamic framework that allows, for example, the continuous monitoring of risks associated with an organization. The risk control self assessment module 200 in general allows the entering, documentation, assessment, scoring, escalation, testing, oversight and certification of various risks for the organization.

The reporting module 600 can be, for example, permission based, and allows full customizable reporting of any aspect of the risk management and mitigation system 100. As alluded to earlier, logging of various activities within the risk management and mitigation system can be enabled and, for example, based on permissions, information associated with the risk control self assessment, or the like, trigger the recording of an event within database 800. The database 800 can be obviously split into one or more separate databases and can be, for example, one or more relational databases. The user interface module 900 is adapted to provide the necessary user interfaces to one or more users and/or administrators that may be present on, for example, a personal computer (not shown) connected to the network 10, via link 5. However, it should be appreciated, that the user interface module 900 can also be configured such that alerts, messages, and the like can be customizable and based on, for example, the intended user, the equipment the intended user may be using to communicate with the risk management mitigation system, or the like. Messaging and workflow, as discussed hereinafter in relation to the workflow module 400 and the content module 320, can cooperate with the user interface module 900, and send various messages to one or more individuals or groups associated with the risk management and mitigation system. Similarly, the alert module 1000 can send alerts to one or more individuals or groups managed by the risk management and mitigation system 100. The audit module 1200 allows either internal or external auditing, or some combination thereof, of any aspect of the risk management and mitigation system 100. It should be appreciated that an auditor's access to the system can also be regulated by rights established through the administration module 300.

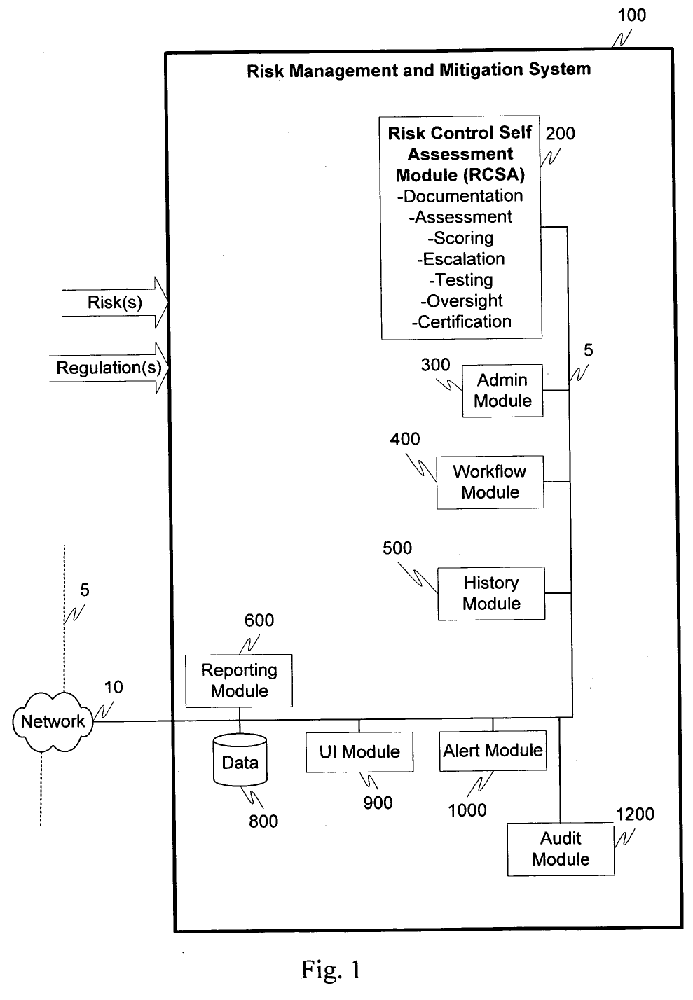

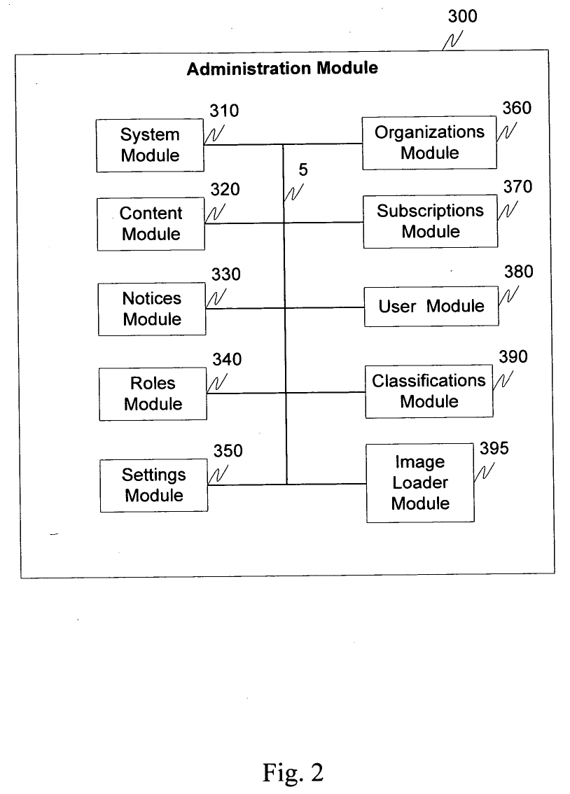

FIG. 2 illustrates in greater detail the administration module 300 illustrated in FIG. 1. In particular, administration module 300 comprises a system module 310, a content module 320, a notices module 330, a roles module 340, a settings module 350, an organizations module 360, a subscriptions module 370, a users module 370, and a configuration module 390, all interconnected by link 5.

The system module 310 provides a user, such as an administrator, with the ability to review information such as the status of the system and to run reports on the system. Items that can be managed by this module include viewing users, the status of the database 800, with an option to report on this status, the ability to restart the system, as well as such information as server information, e-mail information, version information, and the like. The system module 310 cooperates with the UI module 900 to provide the various interfaces necessary to access and/or modify the system status.

The content module 320 allows users, such as administrators, to create and delete messages and to create, view, modify and delete attributes associated with a message. The user can create, view, modify and delete a message subject or body as well as create, view, modify and delete reusable content blocks that can be included in messages. These messages can be previewed by transforming them against a sample data file such that format will appear as it would to a user.

The messaging module 320 allows users to modify existing messages without necessarily having to know, for example, XML syntax, and also allows users to create new messages to users with, for example, subscriptions that they create with the subscriptions module 370. Additionally, the content module 320 allows the deletion of items, and creation and/or modification of a message based on a template.

For example, to create a new message, a user would click on a “new” icon in, for example, a toolbar in a message interface. The content module 320, in cooperation with the user interface module 900, could display an entry form for creating a new message. The user would then enter a name and select the event type associated with the item and optionally enter a description. The user can also optionally declare arguments associated with the message. The content module 320 enables the controls that are dependent on event type and available for the item. Additionally, and optionally, for messages, the user can select a report attachment and compose the message subject. Upon completion of the body of the message, the user can save the message that is then written into the database 800. Furthermore, the user can preview one or more of the message, including any arguments associated with the message and can close the message without saving.

The content module 320 is further capable of operation in multiple different modes at least including an administration mode and a configuration mode. In the administration mode, the content module 320, in cooperation with user interface module 900, displays a “message” and a “text block” interface and when in the configuration mode additionally displays an advanced block area, a reports area, a samples area, a variables area and a schema area.

Generally, an element is representation of an argument, label, variable, text block or advanced block. Elements can be included in messages and text blocks, and an argument is a parameter(s) that can be passed to a message or text block. The label is the name given to a particular area of the user interface. A variable is a parameter that points to other areas of the risk data. Variables can be conditional or a value where conditional variables can be used as part of a condition and, for example, as a subscription. A text block is a section of text and/or code that can be included in messages and other text blocks. An advanced block is a more advanvced section of text and/or code and can be included in messages and text blocks. The message can be sent to either an external user via, for example, an e-mail, or into an internal user as a notification with a message being an attribute of a subscription.

The messages area is further divided into two sections, a messages list and a message detail. The message list displays certain attributes, such as name, description, event type, or the like, of all messages in the interface. The messages detail portion includes an attributes area, a compose area and a preview area. The attributes area displays attributes of a selected messages, such as the name, description, event type, declared arguments list and report attachment and, for example, if an attribute can not be modified, the system can alter the appearance of that attribute indicating modifications are not possible. The compose area allows users to edit the subject and body of the message using, for example, a simplified XML language. The preview portion displays a read-only view of the subject and body of the message as it would appear to a user.

The text blocks area includes a text blocks list and a text detail. The text blocks list displays certain attributes, such as name, description and event type for all text blocks. The text detail has two areas, an attributes area that displays attributes of a selected text block, such as name, description, event type and arguments, and a compose area in which users can edit the text block using, for example, the simplified XML language as previously discussed.

In the configuration mode, an advanced blocks area is displayed within the advanced block list that displays certain attributes, such as name, description, and event type, of all advanced blocks as well as an advanced blocks detail area having an attributes area that displays the attributes of selected advanced blocks as well as a compose area that provides a user an area in which modifications to the advanced blocks can be performed.

The variables area includes a variables list area that displays certain attributes, such as name, event type, variable type of all variables as well as a variables detail area that allows the defining of an event types as well as the assignment of a variable names and identification of the variables either as a conditional or a value variable. The preview area further allows the display of a read-only view that transforms the variables to assist users in verifying that the variables point to the correct data.

The reports area includes a report list area and a reports detail area that further includes attributes composed in the report portion.

A samples area includes a samples list area and a samples detail area that further comprises an attributes and a compose area. The schema area includes a schema list area and a schema detail area.

To create a message, the message area is selected and the user selects, for example, a new messages icon. Upon entry of the required fields, the user can save the message that can then optionally be validated by the system to ensure that its syntax is appropriate. To create a text block a new text block icon can be selected and in a similar manner, upon entry of the required fields, text block can be validated, saved in the database and added to the text blocks list pane. A similar procedure is invoked for the advanced blocks, reports and samples portion of the content module 320.

The notices module 330, in cooperation with the user interface module 900, can display to, for example, an administrator, an interface allowing the management of notices. Notices can be listed by title, status, expiration date, creation date, last updated date, and the like. Notice data associated with each notice can include, for example, the title, summary, text information, status, as well as associated roles and/or organizations. The notices module 330 also cooperates with the messages module 320, roles module 340, organizations module 360 and subscriptions management 370 to ensure notices are sent to the proper entities upon, for example, an action being taken, a need for an action to be taken, system information, or the like.

The roles module 340 cooperates with the users module 370 and the organizations module 360 such that individual roles within the system can be defined. For example, roles can be defined based on a user's position within an organization, a template, or the like.

The roles module 340 further allows the defining, modification, creation and deletion of roles within the system. Attributes associated with these roles include permissions, profile(s), with further data including role data, classification mapping and assigned users.

The settings module 350, again in cooperation with user interface module 900, allows management of basic system preferences such as, for example, attachment file size limits, e-mail information, notifications, general preferences, and the like.

The organizations module 360, allows the defining and editing of organizations within, for example, a corporation. The organization can be displayed in, for example, a tree-type structure with users and/or roles assigned to one or more branches within the tree.

The subscriptions module 370 allows the management of subscriptions that can be categorized by event type, event, condition, and message name. Subscription data includes the event type, such as a risk, the event, such as approved or rejected, the filtering condition, such as whether the risk is new, a delivery type and a message name as well as arguments. Furthermore, notifications based on roles can be associated with the subscription data as well as, in cooperation with the user interface 900, a preview window provided to enable the preview of a subscription.

In general, the subscriptions module 370 allows a user, such as an administrator, to view and modify attributes of a subscription as well as to create and delete subscriptions. The subscriptions can be customized to specify what roles receive a notification for a particular subscription. Furthermore, notifications for a specific subscription can be viewed, and argument values created that are passed to a message type when it is transformed into a notification. Furthermore, the event type associated with the subscription can be viewed and edited and conditions defined to further specify the event that triggers a notification. The subscriptions module 370 further allows the message delivery method to be edited such that, for example, the format can be textual, an e-mail, an application notification, or the like.

The users module 370 allows the creation, editing and deletion of one or more users associated with the system. User information such as name, phone number, e-mail address, password, login information, authentication information, status, and the like can be managed by the user administration module 1480, as well as associated organizations and/or roles managed.

The classification module 390 allows the creation, editing and deletion of classifications that can be applied to various modules of the system and mapped to various roles. Classifications included in this module allow users to uniquely model, for example, the compliance initiatives, risk assessment factors and processes that are unique to the institution's definition of the risks that are necessary to monitor and manage. Classifications also allow users to notify groups or sub-groups of users of changes to risks in their particular areas or interest or expertise. The classifications mode is divided into two sections, a classifications list and classification detail. The classifications list displays certain attributes, such as name, location, type, or the like, of all classifications in the interface. The classification detail portion includes a data area and a value editor area.

The data area displays attributes of a selected classification, such as the name, sub-name, type, location, style and position, and, for example, if an attribute cannot be modified, the system can alter the appearance of that attribute indicating modifications are not possible. The data area also allows the user to preview classifications as they would appear to the user. The value editor area allows users to edit the specific values associated with a classification.

To create a classification, the classifications area is selected and the user selects, for example, a new classification icon. Upon entry of the required fields, the user can save the classification that can then optionally be validated by the system to ensure that its attributes are consistent. Upon completion of the attributes and values of the classification, the user can save the classification that is then written into the database 800. The image loader module 395 allows the extraction and loading of system information.

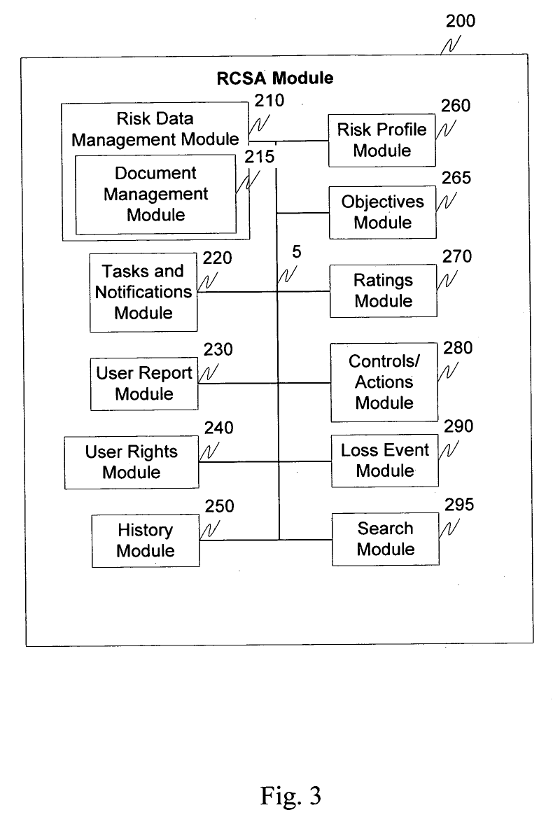

FIG. 3 illustrates an exemplary embodiment of the risk control self-assessment module 200. The Risk Control Self-Assessment (RCSA) module 200 comprises a risk data management module 210 that includes a document management module 215, a tasks of notifications module 220, a user report module 230, a user rights module 240, a history module 250, a risk profile module 260, a ratings module 270, a control/actions module 280, a lost event module 290 and a search module 295, all interconnected by link 5. It should be appreciated that various other componentry such as processor(s), controllers, I/O interfaces, memory, network interfaces, modem(s), and the like, may also be included as appropriate.

In operation, and upon logging in via, for example, a password or network authentication, a user is presented with a summary page, such as a “home page” from which the user can navigate to review risks, add new risk(s), access tasks and notifications, access administrative notices, perform an audit, review controls, and the like depending on the role of the user.

For example, if the user is a line manager of other individual authorized to enter new risks, the user can enter one or more risks into the risk management and mitigation system 100. In particular, the risk and associated information is managed by the risk data management module 210, with supporting documentation managed by the document management module 215. This supporting documentation could be any type of appropriate documentation that can be associated with and stored in the database 800 and/or referenced to, for example, a location where the information can be found.

To enter a risk, and in cooperation with the user interface module 800 and the user rights module 240, a user elects to add a risk to be managed by the risk management and mitigation system 100. In this process, the risk is given an associated ID, regulations pertaining to the risk identified, a business unit with which the risk is associated identified, the objective under which the risk falls selected, as well as, for example, such information as the creator, creation date and/or any other relevant information established. The risk is also assigned a name, with one or more of these fields capable of being searched by the search module 295 as discussed hereinafter.

Associated with the risk, ratings that relate to the impact, likelihood and direction of the risk are selected. Furthermore, controls that have a control rating and are associated with a risk can have actions assigned to one or more assignees or groups established within the system. These controls and actions are managed by the controls/actions module 280 in cooperation with the user interface module 900.

The lost event module 290 can also cooperate with the risk data management module 210 such that loss events can be entered if the risk has associated losses. Information such as the financial impact, type of losses, date of loss, description of loss and associated classifications can be managed and stored as well as the logging of, for example, the individual entry in the loss data module stored in the database 800.

The history module 250 is capable of maintaining a history of, for example, a particular user's activities, that can be filtered, sorted and/or organized by date, activity, risk identifier, or any other information as needed. Furthermore, as with the rest of the features available to a user, the history can have permission-based access based on, for example, a user role as well as include access restrictions to ensure integrity of the system. For example, line managers can be given the permission to view any aspect of the history for which they were the creator, however, have no rights to modify or delete the history.

The objectives module 265 also cooperates with the risk data management module 210 to allow the establishment of profiles and key performance indicators with each objective. Each objective has a name, an identifier, a category, a business unit, and can include the creator and status information such as the update or the creation date. The profile of each objective includes objective information such as the description and classifications such as strategy, operations, compliance and reporting. Furthermore, as with any aspect of the risk management and mitigation system 100, there is the option to include attachments to support the objective. There is also the option to add one or more key performance indicators to the objective with each key performance indicator having a goal, status, measurement-type, frequency, and, optionally, supporting documentation.

As previously discussed, the administration module 300 allows the creation, administration and management of an organizational tree, which can establish the framework for user roles and permissions within the risk management and mitigation system 100. Each level in the tree can have associated roles and permissions that can then be delegated to users falling into that organizational branch. For example, there could be a banking group, a finance group and a technology services group, with the financing group having “accounting,” “investment” and “receivables” subgroups. An administrator, with the cooperation of the administration module 300 and the user rights module 240 can restrict users activities based on, for example, the branch or the organization with which they are associated. Additionally, a user profile, can be established that corresponds to one or more branches within the organization, and users and/or roles derived from that profile.

The risk profile module 260 provides analysis and a graphical representation of a risk. In particular, the risk profile module 260 utilizes a scoring and rating system to rank a risk according to a risk level rating, overall control rating, residual risk rating, risk levels score, overall control score and residual risk score. The risk profile module 260 also manages, in cooperation with the risk data management module 210, and the user interface module 900, the organization, color-coding, and presentation of the status of the risk to a user. As discussed hereinafter in relation to the risk profile exemplary screen shot, the risk profile module 260 has the capability of using color-coding to facilitate drawing a user's attention to critical or other items that are in need of attention or that warrant consideration.

The ratings module 270 allows users to rate the impact, likelihood and direction of a risk. Within each of these ratings, the ratings module 270 allows the user to input rational and one or more supporting documents justifying the rating. These ratings can include, for example, the impact of the risk, the likelihood of the risk and the direction of the risk.

The control/actions module 280 provides the management and reconciliation of controls throughout the risk management and mitigation system 100 in cooperation with the tasks and notifications module 220 and the content module 320. In particular, controls are added and associated with one or more actions with the control having an evaluation rating and being assigned to a particular classification. As previously discussed, these controls can be reviewed by supervisory personnel who ensure consistency within the risk management and mitigation framework. Similarly, actions can be defined and assigned to one or more assignees based, for example, on the type of risk. As with a control, an assigned action has classification and an assignment to particular assignee or group of assignees. Furthermore, as with the controls, the actions can be reviewed by one or more supervisors to ensure consistency within the risk management and mitigation framework.

The lost event module 290 allows the entry and management of loss events as well as specifics relating the loss, financial impact, and associated classifications.

The reporting module 600, as alluded to earlier, allows the searching, compilation and reporting of any aspect of the risk management and mitigation system 100. The reports can be user-centric, risk centric, for an audit, catered toward third party review, and/or can include any information in any format as appropriate.

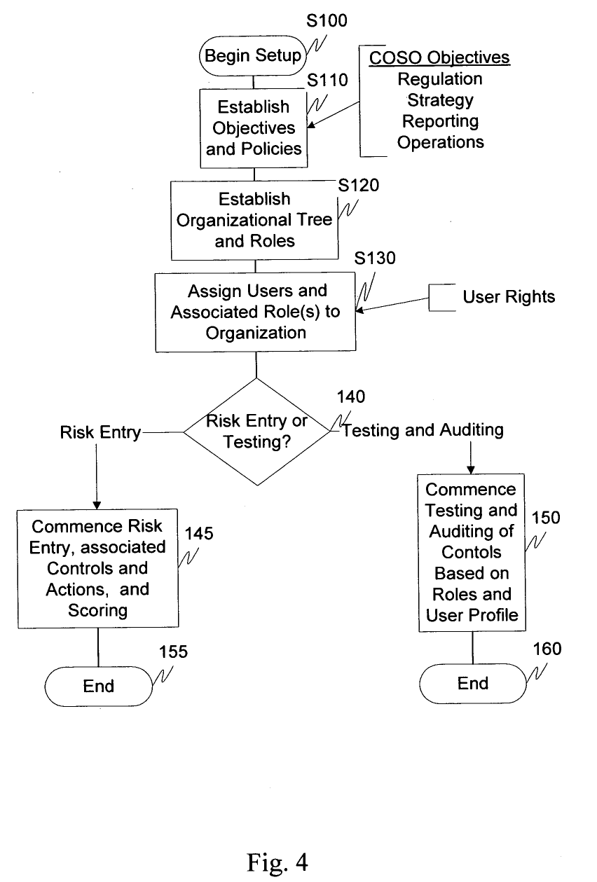

FIGS. 4-10 illustrate various exemplary flowcharts associated with risk mitigation and management workflow. In particular, FIG. 4 illustrates an exemplary high-level flowchart outlining a method for setting-up the risk management and mitigation system. In particular, control begins in step S100 and continues to step S110. In step S110, one or more objectives and/or policies are established taking into consideration, for example, COSO objectives such as regulation, strategy, reporting and operations. Next, in step S120, an organizational tree and associated roles of the entity(s) for which risk management and mitigation is sought is developed. This organizational tree can allow the ability for user permissions to be easily assigned to one or more users within a branch(s) of the organizational tree. Then, in step S130, one or more users and their accompanying roles are input into the system along with an assignment of user rights and/or permissions. Control then continues to step S1140.

In step S140, a determination is made whether the user is entering the risk features of the system or the testing and auditing features of the system. For risk entry, control continues, after the preliminary setup and initialization of the system has been completed, to Step S145 where risk entry, controls, actions and scoring can commence that allows for risk management and mitigation. Control then continues to step S155 where the control sequence ends.

Otherwise, for testing and auditing, control continues to step S150 where the testing and auditing of controls based on roles and the user profile commences. Control then continues to step S1160 where the control sequence ends.

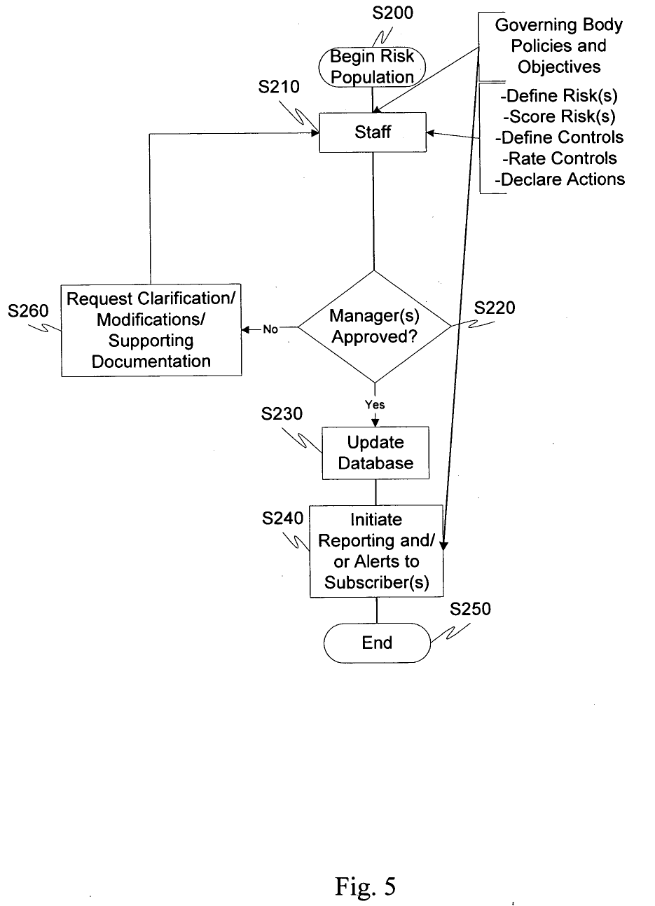

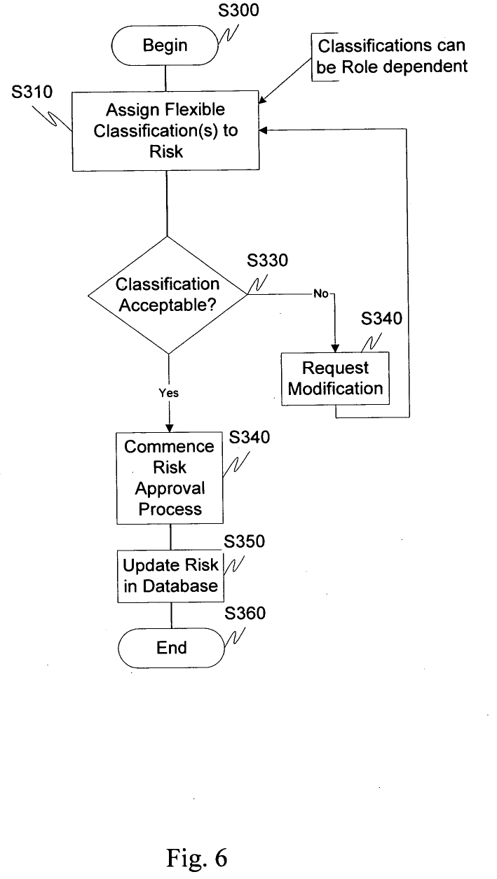

FIG. 5 illustrates an exemplary method of entering a risk into the risk mitigation and management system. In particular, control begins in step S200 and continues to step S210. In step S210, one or more users, such as staff, either jointly or collaboratively enter a new risk and associated information about the risk such as a description, the business unit to which it is attributable, under which objective it falls, accompanying supporting documentation, and the like, into the system. Furthermore, classifications are assigned that allow an indication of which regulation governs the risk, the process, and/or subprocess, any financial line item data, and/or assessment factors. The assignment of classifications to a risk can be more fully appreciated with reference to FIG. 6 discussed hereinafter.

Next, in step S220, one or more managers review information regarding the newly entered risk and associated documentation, if appropriate, and a determination is made whether the risk should be assumed and, if approved, control passes to step S230. Otherwise, control continues to step S260 where a message/task is returned to the risk creator indicating that clarification, modifications, and/or supporting documentation is needed before approval can be granted.

In step S230, the database is updated and control continues to step S240 where any appropriate reporting and/or alerts are sent to subscribers. Control then continues to step S250 where the control sequence ends.

FIG. 6 illustrates a control process for the assignment of classifications to a risk, or any related area such as objective, control test, control audit, action, etc. In particular, control begins in step S300 and continues to step S310. In step S310, one or more classifications are associated with the risk. These classifications can be, for example, location dependent such that a predefined grouping of classifications are selectable, from, for example, a pull-down menu, based upon the system module. Next, in step S330, classifications associated with the risk can be reviewed by one or more supervisors, and if the assigned classifications are acceptable, control jumps to step S350. Otherwise, control continues to step S340 where an updating and/or modification of the assigned classification is requested.

In step S350, the risk approval process continues with the risk being updated in the database in step S360. Control then continues to step S370 where the control sequence ends.

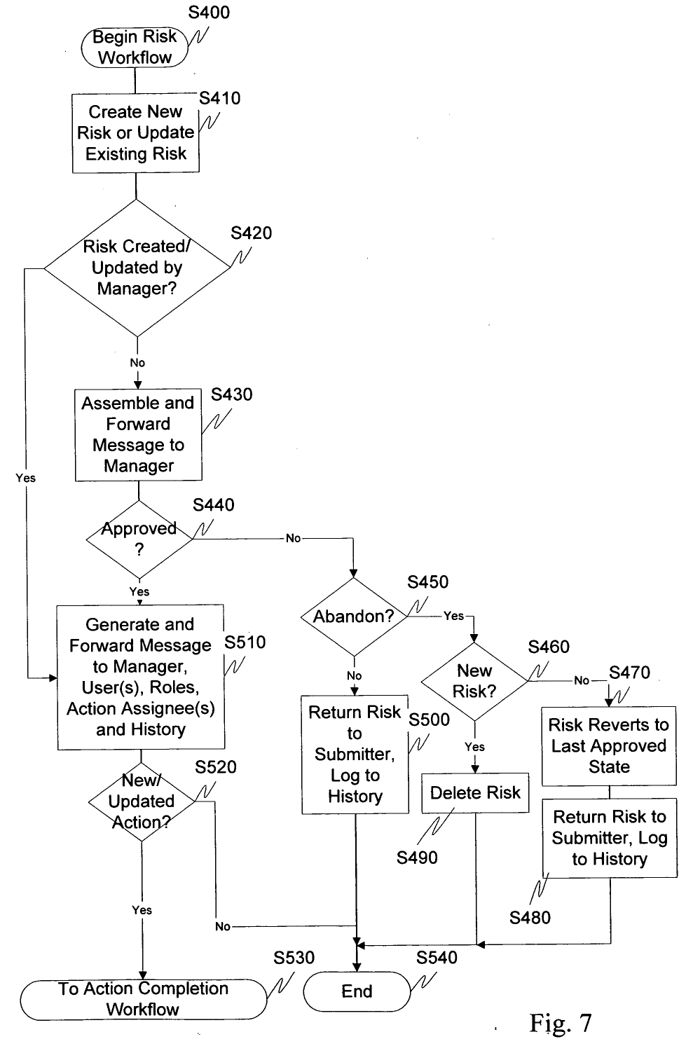

FIG. 7 illustrates an exemplary embodiment of risk workflow. In particular, control begins at step S400 and continues to step S410. In step S410, a new risk is created or an existing risk updated. In step S420, a determination is made whether the risk was created and/or updated by a manager. If the risk was created and/or updated by a supervisor, control has the capability of jumping to step S510. Otherwise, control continues to step S430.

In step S430, a message is assembled and forwarded to a supervisor for approval. In step S440, a determination is made whether the risk is approved. If the risk is approved, control jumps to step S510. Otherwise, control continues to step S450. In step S450, a determination is made whether to abandon the risk. If the risk is to be abandoned, control continues to step S460, otherwise control jumps to step S500. In step S460, a determination is made whether the risk was new. If the risk was new, control jumps to step S490 where the risk is deleted upon which control continues to step S540 where the control sequence ends.

Otherwise, the risk reverts the last approved state in S470 and in step S480 the risk is returned to the submitter and the chain of actions logged to the history. Control then continues to step S540 where the control sequence ends.

In step S500, if the risk is not to be abandoned, the risk can be returned to the submitter indicating that it was not approved, for example, including the reason(s) it was not approved, and logged to the history. Control then continues to step S540 where the control sequence ends.

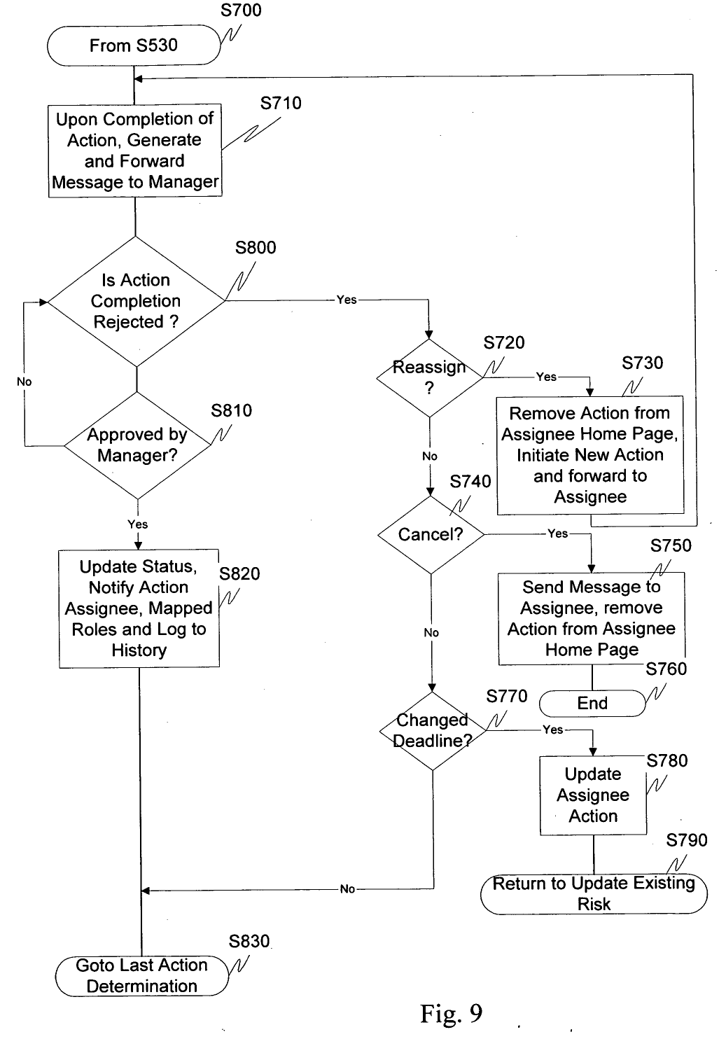

In step S510, a message is generated and forwarded to the manager, user(s), roles, action assignee(s) and history. Control then continues to step S520 for the determination of whether a new or updated action exists. If an open action does not exist, control jumps to step S540 where the control sequence ends. Otherwise, control continues to step S530 to FIG. 9.

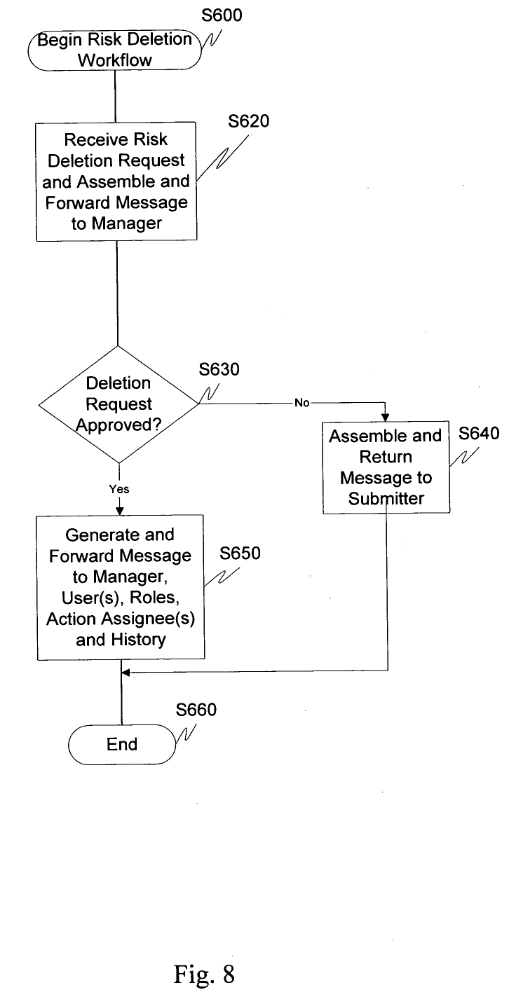

FIG. 8 illustrates and exemplary risk deletion workflow. Control begins in step S600 and continues to step S620. In step S620, a risk deletion request is received and a message is assembled and forwarded to the manager indicating the deletion of a risk has been requested. Then, in step S630, a determination is made whether the supervisor has approved the deletion request. If the supervisor does not approve the deletion of request, control continues to step S640 where a message is generated and returned to, for example, the submitter indicating the denial of the deletion request. Otherwise, control jumps to step S650 where a message is generated and forwarded to all appropriate entities, such as manager(s), user(s), roles, history and action assignee(s), indicating the risk was deleted. Control then continues to step S660 where the control sequence ends.

FIG. 9 is a continuation of the workflow illustrated in FIG. 7 for when an action is new/updated. In particular, control begins to step S700 and continues to step S710. In step S710, and upon completion of an action, a message is generated and forwarded to, for example, an appropriate supervisor and/or manager. Next, in step S800 a determination is made whether the action completion is rejected. If the action completion is rejected, control continues to step S720. Otherwise, control jumps to step S810.

In step S720, determination is made whether to reassign the action. If an action is to be reassigned, control continues to step S730 where the assigned action is removed from the assignees homepage and a new task initiated and forwarded to a new assignee. Control then continues back to step S710. Otherwise, control continues to step S740. In step S740 a determination is made whether to cancel the risk. If the risk is to be cancelled, control continues to step S750 where a message is sent to the assignee, and an action removed from the assignees homepage. Control then continues to step S760 where the control sequence ends.

Otherwise, control jumps to step S770 where a determination is made whether the deadline has changed. If the deadline has changed, control continues to step S780 where the assignees action is updated and control continues to step S790 where control continues to the update an existing risk workflow. Otherwise, control continues to step S830 where control continues back to the last action determination workflow.

In step S810, and upon satisfactory completion of the action, the action is approved by a supervisor, such as a manager, and control continues to step S820. Otherwise, if the action is not approved by a supervisor, such as a manager, control continues back to step S800.

In step S820, the status of the action is updated, the action assignee notified and all taken actions logged to history. Control then continues to step S830 where the control sequence ends.

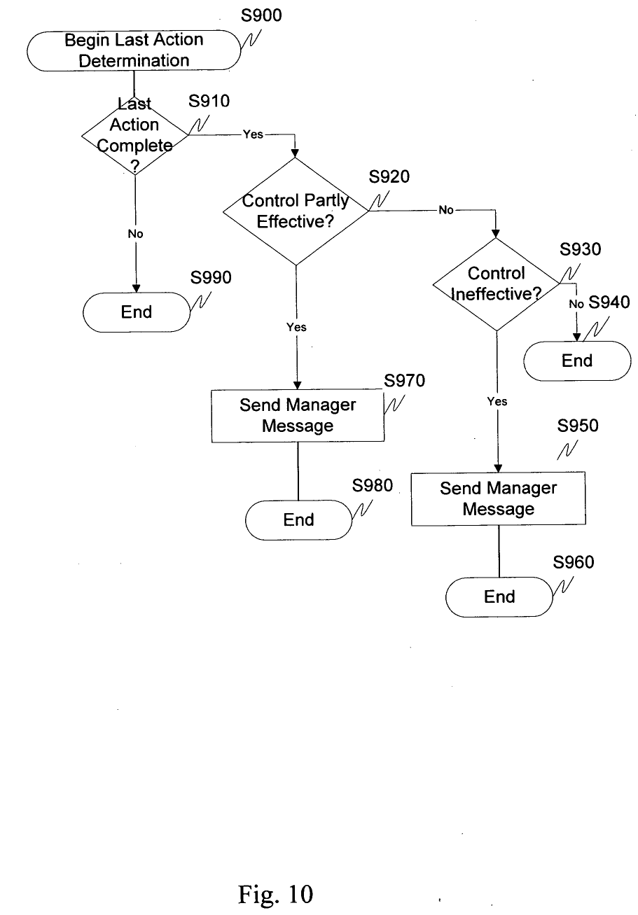

FIG. 10 illustrates an exemplary last action termination workflow. In particular, control begins in step S900 and continues to step S910. In step S910, a determination is made whether all actions have been completed. If they have not been completed, control continues to step S990 where the control sequence ends. Otherwise, control jumps to step S920 where a determination is made whether the control was partly effective. If the control was partly effective, control continues to step S970. Otherwise, control jumps to step S930 where a determination is made whether the control was ineffective. In the control was effective, control jumps to step S940 where the control sequence ends. Otherwise, control continues to step S950 where a supervisor, such as a manager, is sent a message and/or an action item indicating, for example, an action is required. This can then be updated and populated on the manager's homepage, for example. Control then continues to step S960 where the control sequence ends.

In step S970, if the control was partly effective, a message and/or an action can be forwarded to a supervisor, such as a manager, for example, recommending an action. Control then continues to step S980 where the control sequence ends.

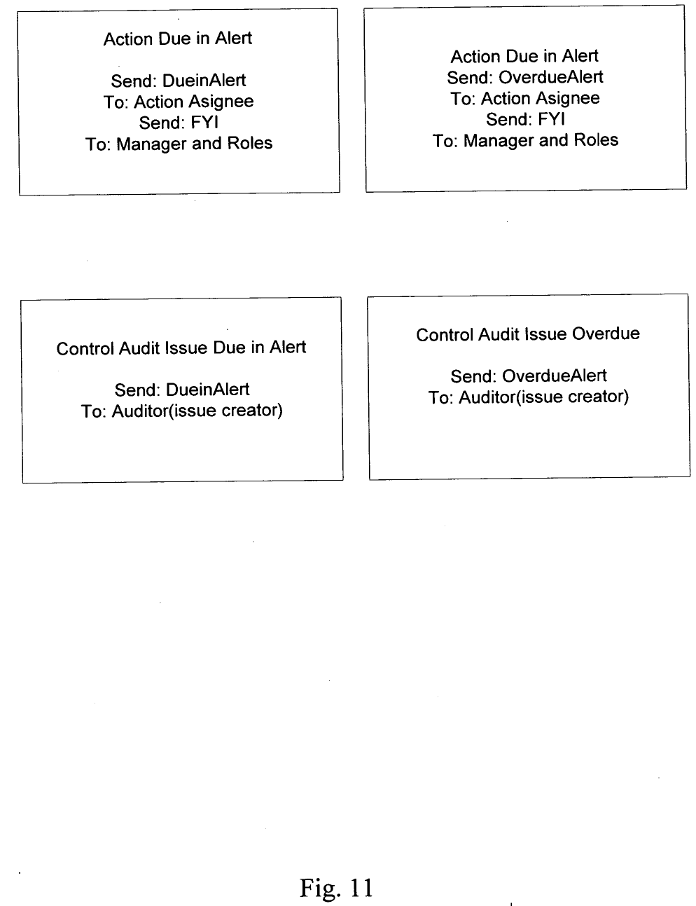

FIG. 11 illustrates various messaging formats and information contained therein that can be used in conjunction with the exemplary embodiments of this invention. In particular, the message formats illustrated in FIG. 11 are directed toward an action due and alert message, a control audit issue due and alert message, and action overdue and alert message and a control issue overdue message.

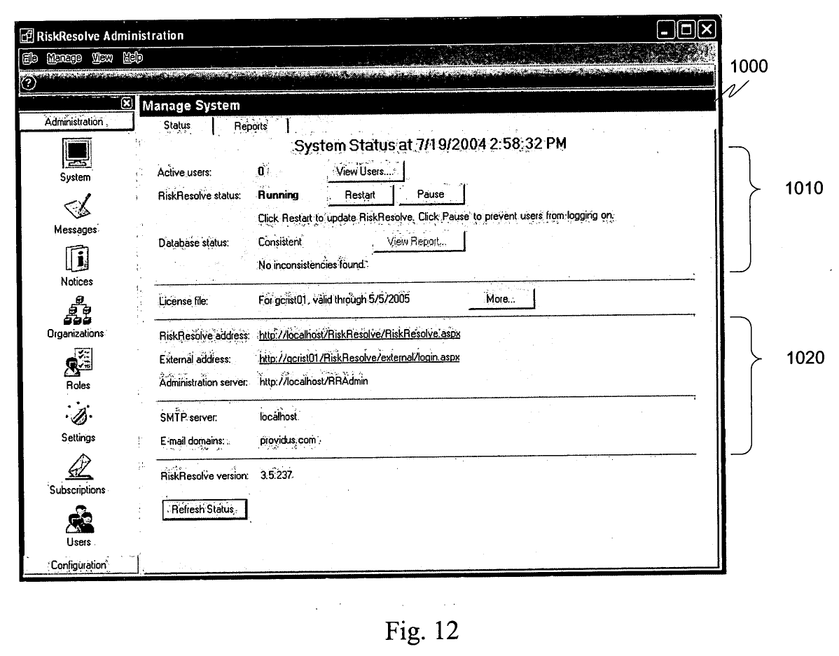

FIGS. 12-21 illustrate various exemplary user interfaces associated with the administration console. The administration console is broken into two sections, an administration console and a configuration console. Within the administration console there are seven sub-consoles: system, messages, notices, organizations, roles, settings, subscriptions and users. Within the configuration console, there are two sub-consoles, classifications and an image loader.

In the system console, various information regarding the system is given such as, for example, the system status 1010, server information 1020, and any other information as selected by, for example, the administrator. This interface, along with all the other interfaces, are capable of being configured, redesigned, reorganized, and the like depending on, for example, particular operating environment, the users and/or administrator preference, a particular companies profile, or the like. In the system administration user interface 1000, an administrator can see real-time information about the system such as the number of active users, the running status of the program and database status. Each of these sub-categories has the capability of being drilled-down into such that further information can be displayed.

The reports user interface 1100 provides access to the entire array of “risk-defining” classifications, the business unit hierarchy, processes and other system descriptors for purposes of creating reports on the institution's risk profile. This interface is constructed in a user friendly manner and provides a drop-down choice for selecting information contained within the inventive system. These reports can be constructed in, for example, HTML, Portable Document Format (PDF), and as an Excel Spreadsheet (.XLS). The inventive system's reporting interface allows an almost unlimited number of reports to be created, stored as a query and selected by the user whenever necessary.

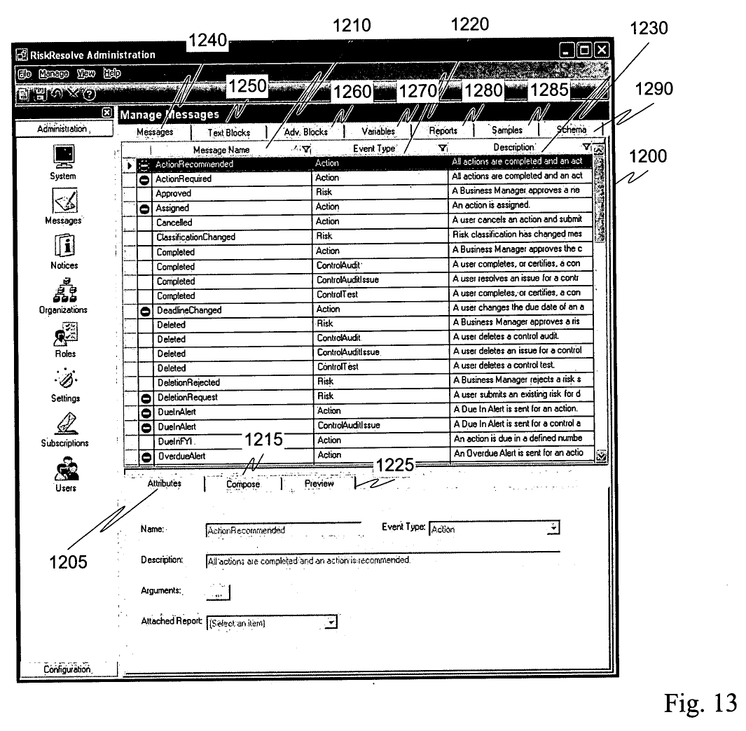

FIG. 13 illustrates an exemplary interface 1200 for the administration of messages. In the message interface 1200, one or more messages can be listed and the corresponding event type and description displayed. Upon selection of a message, the attributes of the message can be displayed in the attributes tab 1205. The compose tab 1215 allows the composition of messages and a preview of the generated message to be displayed and preview tab 1225.

Tabs 1250, 1260, 1270, 1280, 1285 and 1290, text blocks, Adv. blocks, variables, reports, samples and schema, respectively, allow the viewing, creating and editing or various sub-components of the messages shows in the Messages tab 1240.

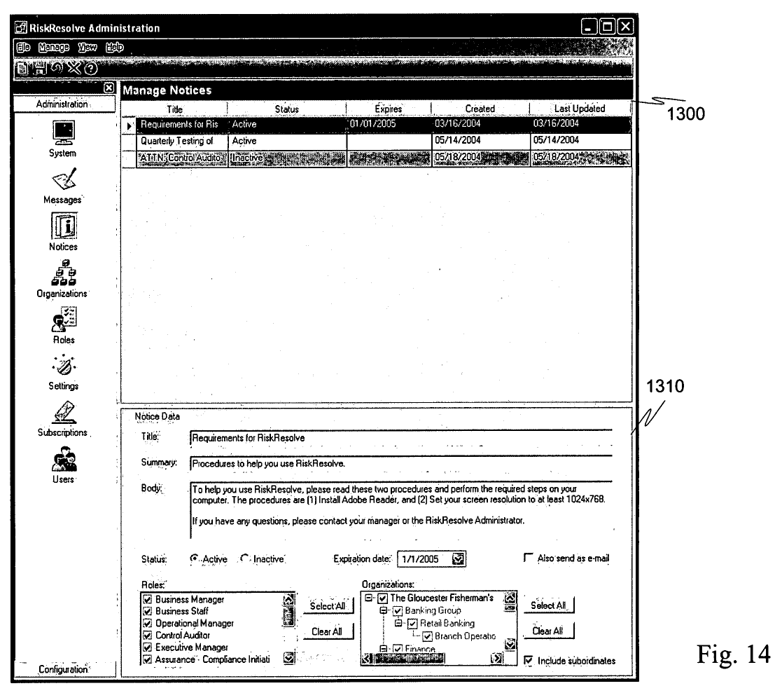

FIG. 14 illustrates the manage notices interface 1300. The manage notices interface 1300 lists one or more notices which can be sorted by, for example, title, status, expiration date, creation date and/or last updated date. The notices interface 1300 includes a data portion 1310 that can include such information as title, summary, body, status information, expiration date information, e-mail options, as well as one or more roles and/or organizations to which the notice is applicable.

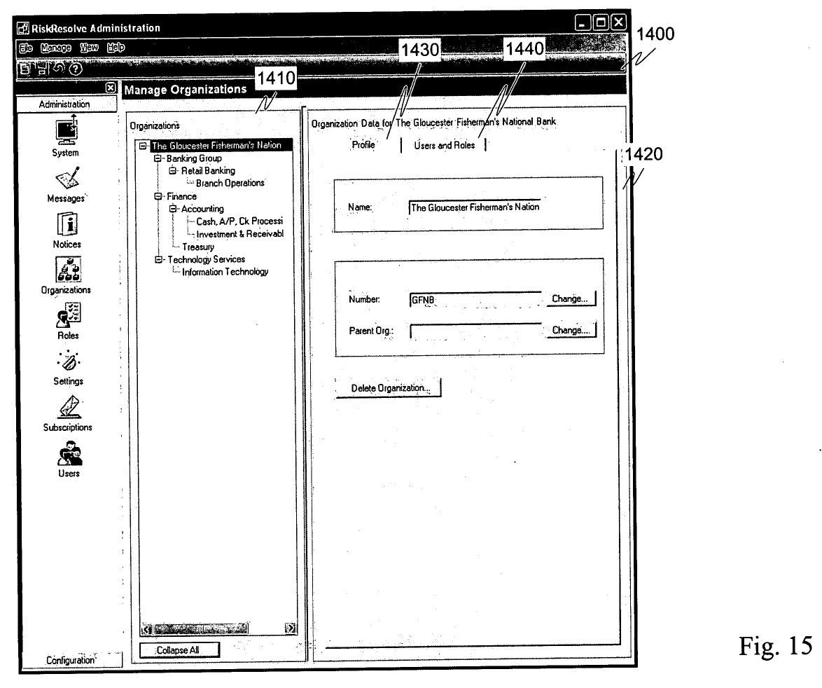

FIG. 15 illustrates the manage organizations interface 1400. The manage organization interface 1400 can include, for example, a graphical representation illustrating the hierarchy of the organization 1410 as well as an accompanying portion 1420 that show specifics about one or more branches within a defined organization. For example, these specifics can include a profile portion 1430 and a user and roles portion 1440.

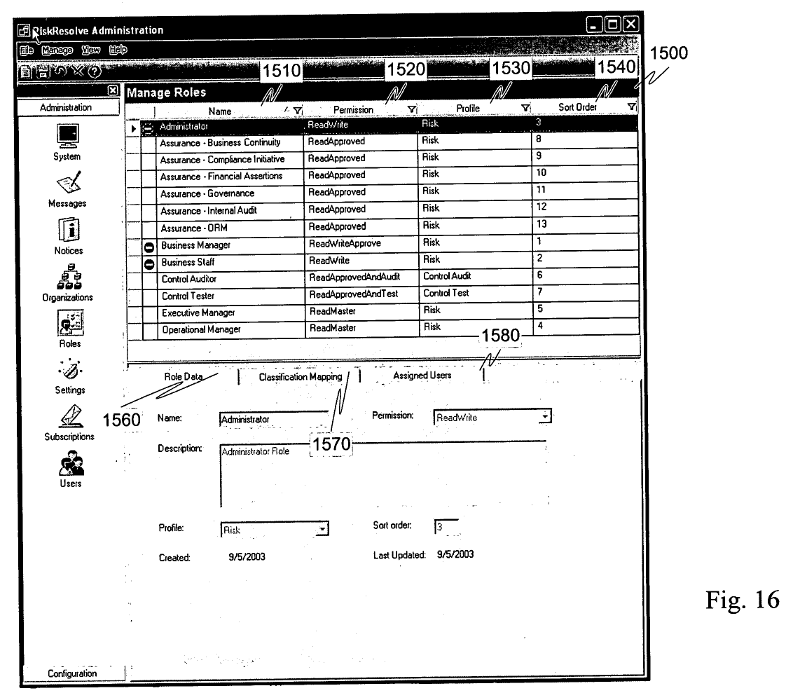

FIG. 16 illustrates an exemplary interface for the management of roles. Within the roles interface 1500, information such as the name 1510, permissions associated with the role 1520, profile associated with the role 1530 and sort order 1540 cab be displayed. Upon selection of a role, the role data can be displayed in 1560 and can include, for example, the name, permissions, description, profile, sort order, creation date, last updated date, creator, and the like. Furthermore, the classification mapping tab 1570 and assigned user tab 1580 allow users to specifically classify the nature of their risks, in particular, by major regulatory requirements and with respect to traditional risk management procedures and practices unique to the operating setting. The assignment of classifications to a risk can be more fully appreciated with reference to FIG. 6.

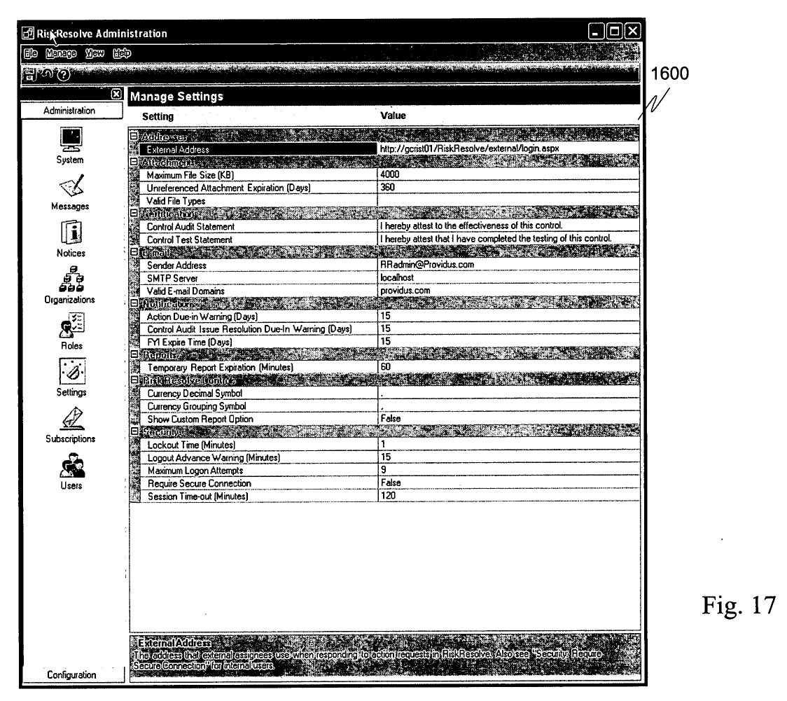

FIG. 17 illustrates the settings interface 1600. In particular, the settings interface 1600 allows the establishment, configuration and maintenance of system settings such as addresses, attachments, certifications, e-mail preferences, notifications, reports, general controls and security. However, it should be appreciated that this list is not exhaustive and can be configured to include the ability to create and maintain any setting in relation to the system.

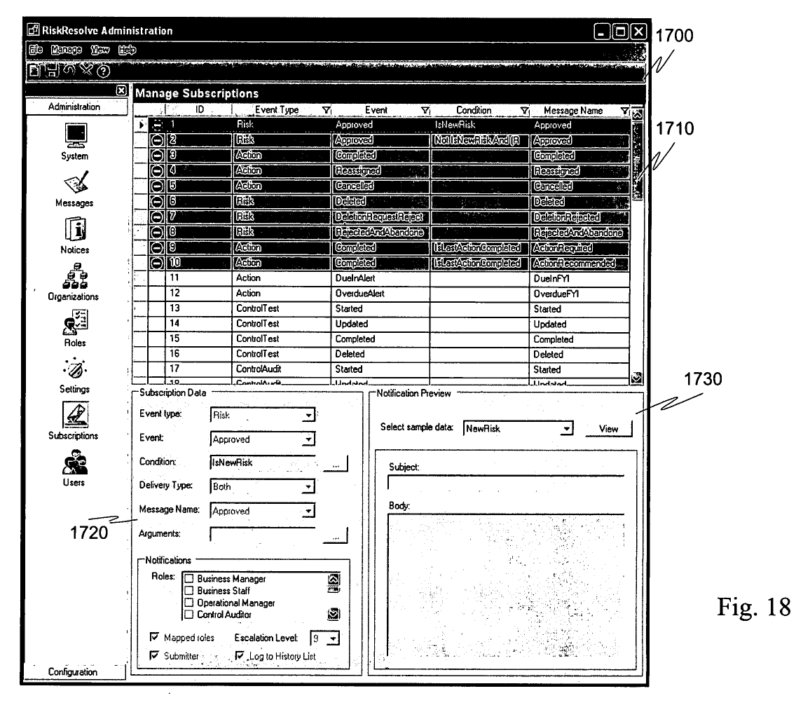

FIG. 18 illustrates the manage subscriptions interface 1700. The subscriptions interface 1700 is broken into three portions, a subscription list 1710, subscription data portion 1720 and notification preview portion 1730. Within the subscription list 1710, subscription identifiers, event types, events, conditions and message names are listed. Upon selection of one of these subscriptions, the subscription data is displayed in the subscription data portion 1720 and can include information such as, for example, the event type, event, condition, delivery type, message name, arguments, notifications, and the like. For the creation of a new message, the notification preview portion 1730 can be used to preview the newly created subscription.

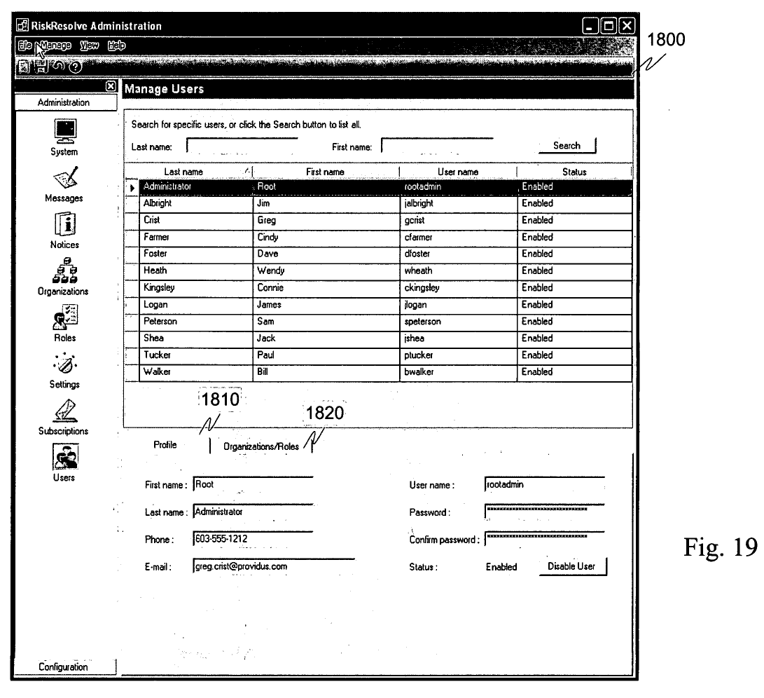

FIG. 19 illustrates an exemplary user management interface 1800. The user management interface allows the addition, deletion, modification, and searching for one or more users associated with the system. Users can be sorted by last name, first name, user name, status, or the like. Furthermore, associated with each user, a profile 1810 can be displayed that highlights such information as the users first name, last name, phone number, e-mail address, username, password, and status. Furthermore, the organizations and/or roles to which the user is associated can be displayed upon the selection of the organization/roles tab 1820.

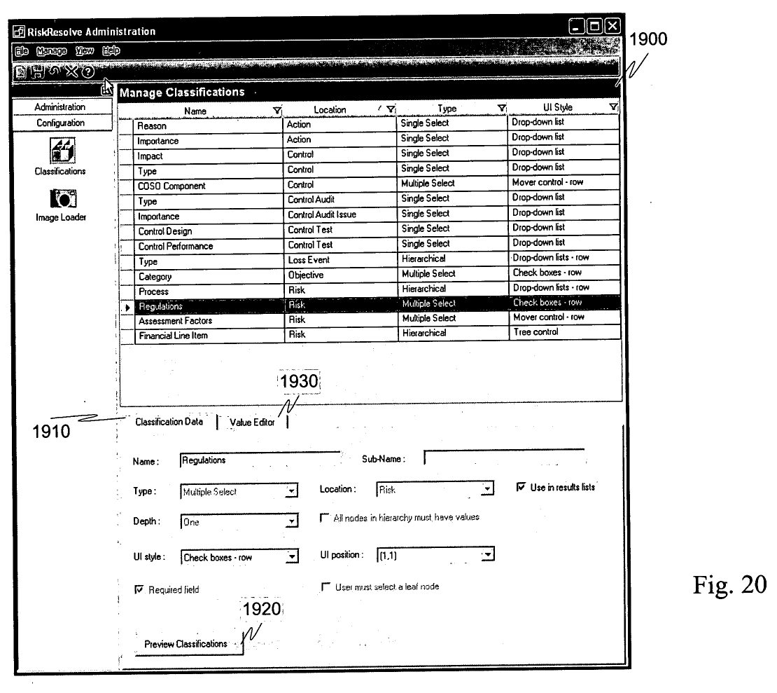

FIG. 20 illustrates the classification management interface 1900. In a similar manor, classifications are displayed and can be sorted by name, location, type, user interface style, or the like. Upon selection of a classification, specifics regard the classification can be displayed in the classification data tab 1910. These specifics can be, for example, name, type, depth, user interface style, sub-name, location, user interface position, and the like. A preview of the classification can be viewed by selecting the preview classifications button 1920 and management of values associated with the classification data entered and/or edited upon selection of the value editor tab 1930.

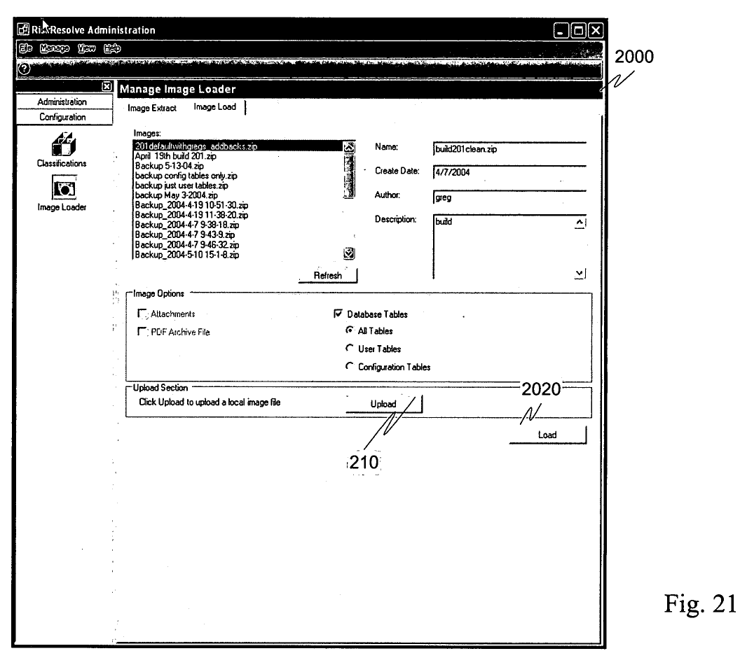

FIG. 21 illustrates the image loader management interface 2000. The image loader interface 2000 allows the extraction and/or loading of images as well as the ability to display information about the images, such as title, path, name, creation date, author, description, image options uploading, via the upload button 210, and loading via the load button 220.

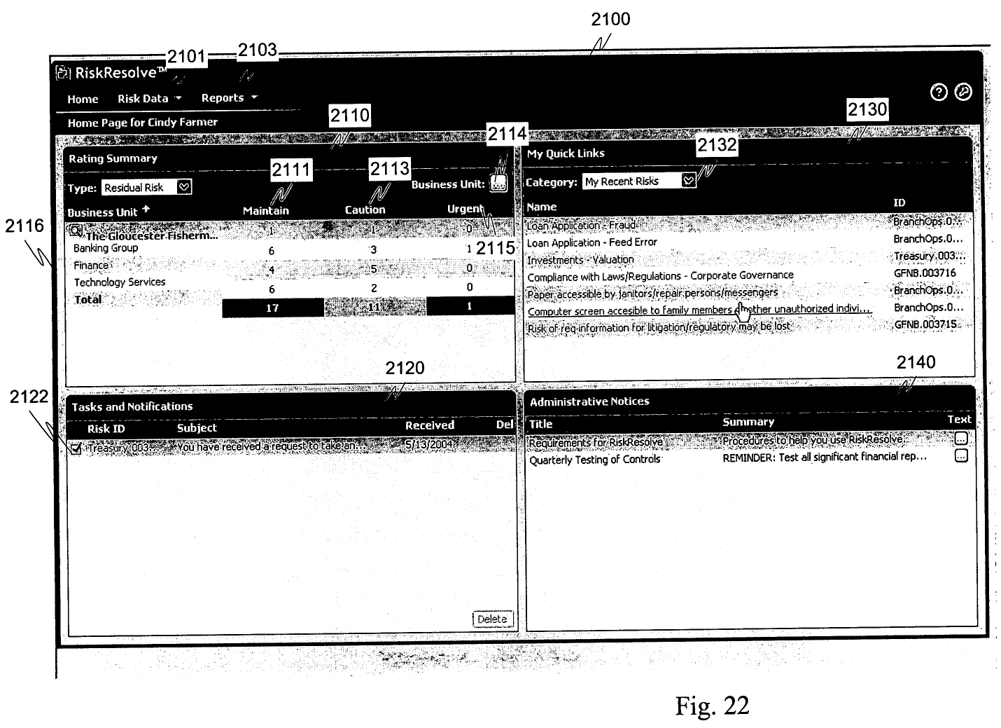

FIG. 22 illustrates an exemplary interface 2100 that is a “homepage” for an exemplary user. The interface 2100 comprises four portions, a rating summary portion 2110, a task and notification portion 2120, a quick link portion 2130 and an administrative notices portion 2140. Additionally, interface 2100 allows quick navigation between a risk data interface, via link 2101, and a report interface, via link 2103, discussed hereinafter.

The rating summary portion 2110 allows the breakdown and display of various types of risks. The type of risk being displayed is governed by the type selection menu 2112. Type categories are, for example, risk level, overall control level and residual risk rating. Additionally, one or more business units are displayed in the business unit portion 2116, with corresponding risks organized by criticality displayed in the “maintain” category 2111, “caution” category 2113 and “urgent” category 2115. These various categories can be color coded, as well as the overall layout modified, for example, based upon the role of the user. For example, a supervisory user may only desire to see all or a portion of the data and thus, for example, could only display risks within the urgent category on the homepage, but of course have access to remaining risk(s) upon selection of an icon (not shown).

The task and notifications portions 2120 includes any tasks and/or notifications the user may have received. In this particular exemplary embodiment, the user has already received one task 2122 which the user can select to display, for example, additional information to complete and enter notes thereon, delete, or the like.

Quick link portion 2130 includes, for example, links to work recently worked on by the particular user. The quick link portion 2130 includes a quick link category menu 2132 from which various categories can be chosen such as, for example, recent risks, fully open risks, currently managed risks, and my reports, tests or audits in progress, saved searches, reports, or the like.

The display portion 2140 is capable of displaying administrative notices to the user. These notices can be sorted by title, summary, text, importance, or the like and, upon selection, can provide greater information to the user and the ability to take an action, if appropriate.

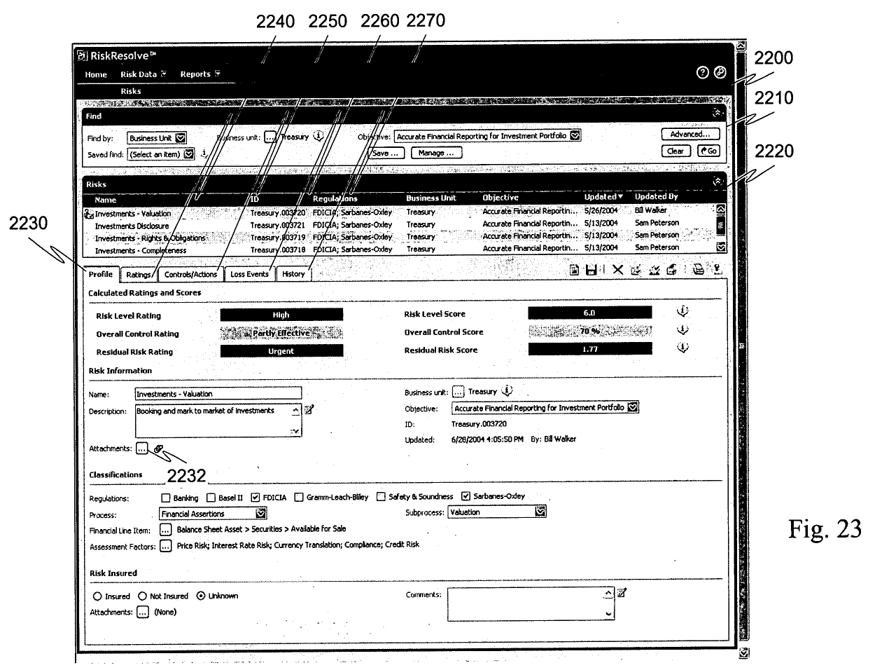

Upon selection of the risk data link 2101, a user can be taken to the risk data interface 2200 illustrated in FIG. 23. The risk data interface 2200 includes a search portion 2210 and a risk portion 2220. The a search portion 2210 allows searching for one or risks by, for example, business unit, objective, word search, or the like. Searches can be saved and stored in, for example, a quick search interface, or the like.

The risks portion 2220 list one or more risks that are, for example, a result of a search. New risks can be added to this list through the selection of a “create new risk icon” as well as deleted, saved, edited, and the like, as discussed hereinafter.

For each risk, tabbed categories of information are available about the risk. These tabbed categories include a risk profile tab 2230, a risk ratings tab 2240, a control/actions tabs 2250, a risk loss events tab 2260, and a risk history tab 2270. Within the risk profile tab 2230, information such as the risk level rating, overall control rating, residual risk rating, risk level score, overall control score and residual risk score can be displayed. The risk rating methodology included in the exemplary process is completely configurable, but in general allows the user to specify an analytical script based a variety of flexible classifications, numerical measures of risk, related probabilities of incurring that risk and a control effectiveness scoring. These analytical measures are calculated in a consistent fashion and used to populate the risk rating summary pane of the home page. The measures are calculated as risk indices that can be monotonically transformed in customer specific fashion, added throughout the organizational hierarchy and viewed as a consistent measure of overall enterprise risk exposure. Additional information about the risk such as the name, description, associated business unit, the relevant objective, identification and last update data can also be displayed. Furthermore, any attachments associated with the risk can be viewed by selecting the attachment icon 2232.

Classifications associated with the risk are also displayed. In the classifications, the applicable regulations, process, financial line item and/or assessment factors can also be displayed, selected and/or edited as appropriate. An insurance portion can also be displayed indicating whether, for example, the risk is insured, if not insured or unknown and, in a similar manner, attachments and/or comments can be accessed and/or displayed.

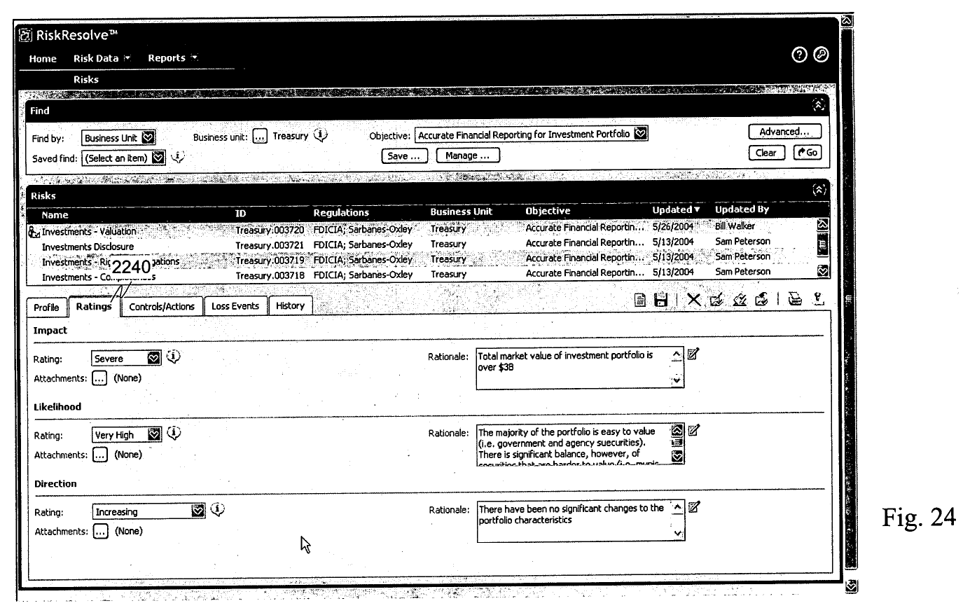

FIG. 24 illustrates the ratings tab 2240 of the risk data interface 2200. In particular, the risk ratings interface allows selection of quantifiers associated with the risk such as the impact, likelihood and direction. Within each category, ratings such as severe, very high, or the like can be attributed to the risks, as well as supporting rational commentary added in conjunction with supporting documentation attachment, as necessary. Similar ratings can be associated with the likelihood and direction that the risk is taking and the information associated with the risk stored in the database.

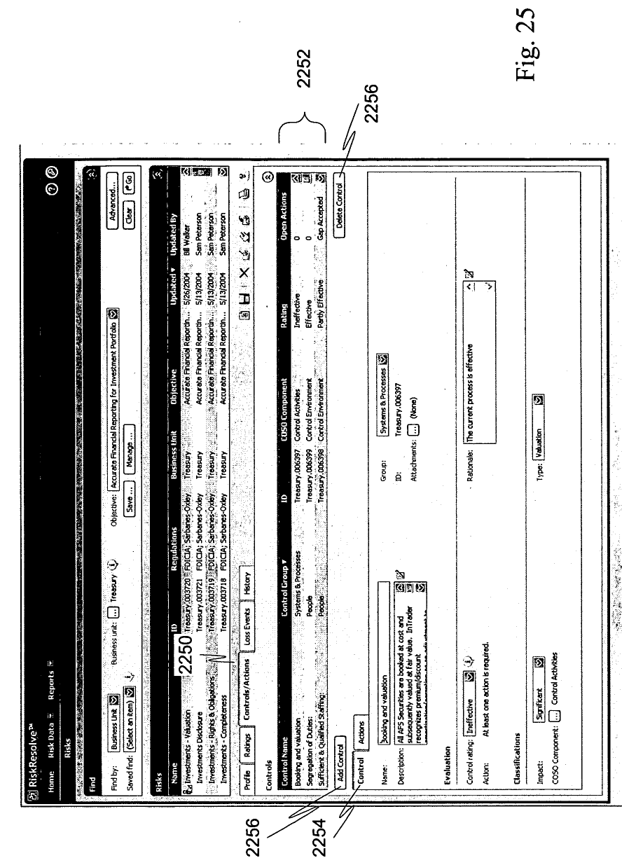

FIG. 25 illustrates in greater detail the control/actions interface 2250. In particular, this figure illustrates the controls aspect of the control/actions tab 2250. Controls illustrated in control list 252 are associated with a particular risk. The addition and deletion of controls can be accomplished through the selection of the “add” and “delete” control buttons 2256. Furthermore, the control interface 2254 provides access to the name, description, group, identifier and other general information about the control, as well as the ability to assign evaluations and classifications to the controls. Evaluations can include information such as the control rating and action, as well as any supporting rational and/or documentation. The classifications can include information on impact, type, control activities, and the like.

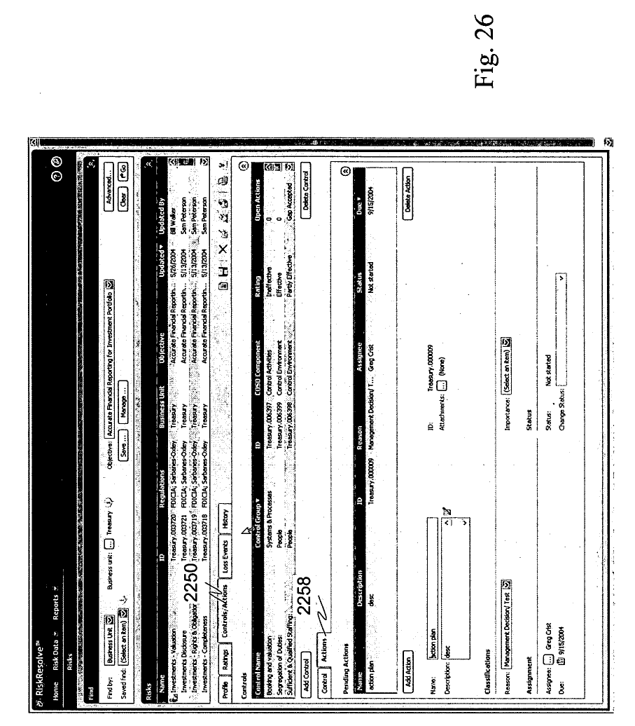

FIG. 26 illustrates in greater detail the actions portion of the control/actions interface 2250. In particular, the actions tab 2258 includes information such as pending actions, as well as the ability to add and delete an action. As with the controls, general information about the action such as name, description, identification, and the like, is displayed along with any appropriate classification as well as a list of the assignee, which is an individual or group of individuals. Furthermore, status information and due date information about the assignment can be displayed within the actions tab 2258.

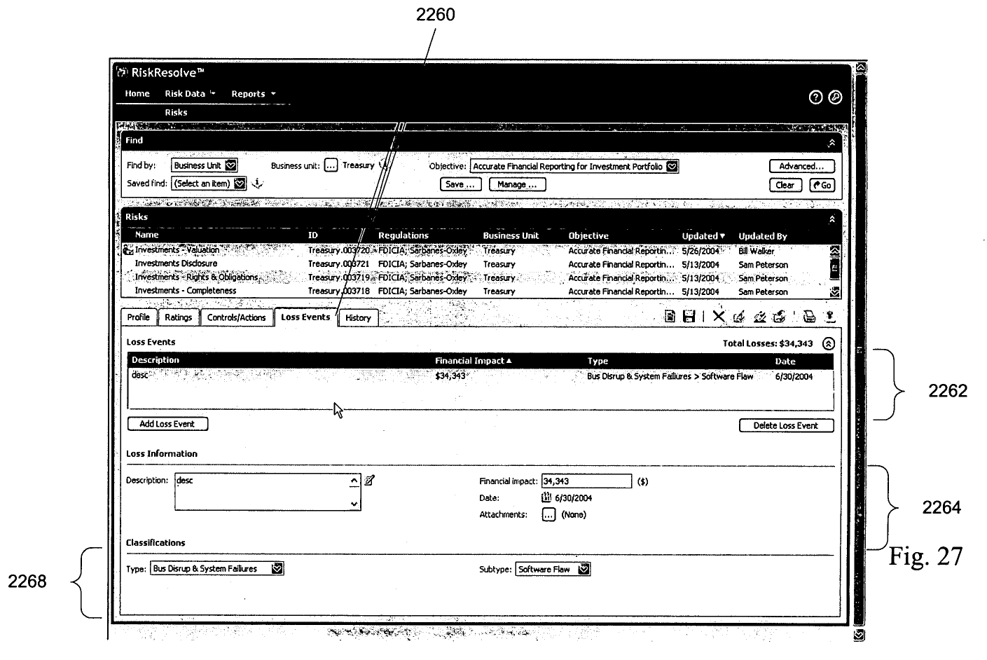

FIG. 27 illustrates in greater details the loss events tab 2260. The loss events tab 2260 includes a list of loss events 2262 as well as buttons that enable the adding and deletion of a loss event. Furthermore, the loss events tab 2260 includes a loss information portion 2264 that displays, for example, a description of the loss, financial impact, date of the loss, as well as the ability to access any supporting documentation. The classifications portion 2268 displays various classification information such as the type and subtype. The type pull-down menu can include categories such as such as the Basel II primary event definitions and the subtype pull-down menu can include further classifiers such as the Basel II secondary event type classifications. Other details can be added to the event type classification schema using the flexible classifications schema included in the exemplary invention.

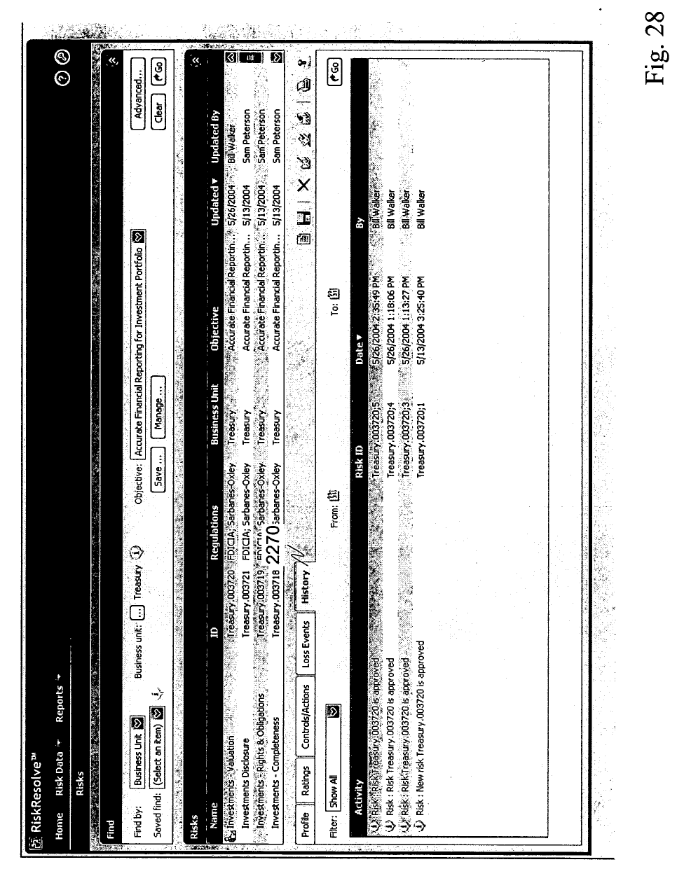

FIG. 28 illustrates in greater detail the history tab 2270. The history interface includes a filterable list of activities, risk identifiers, dates and authors/editors as well as the ability to filter and display from and to specific dates.

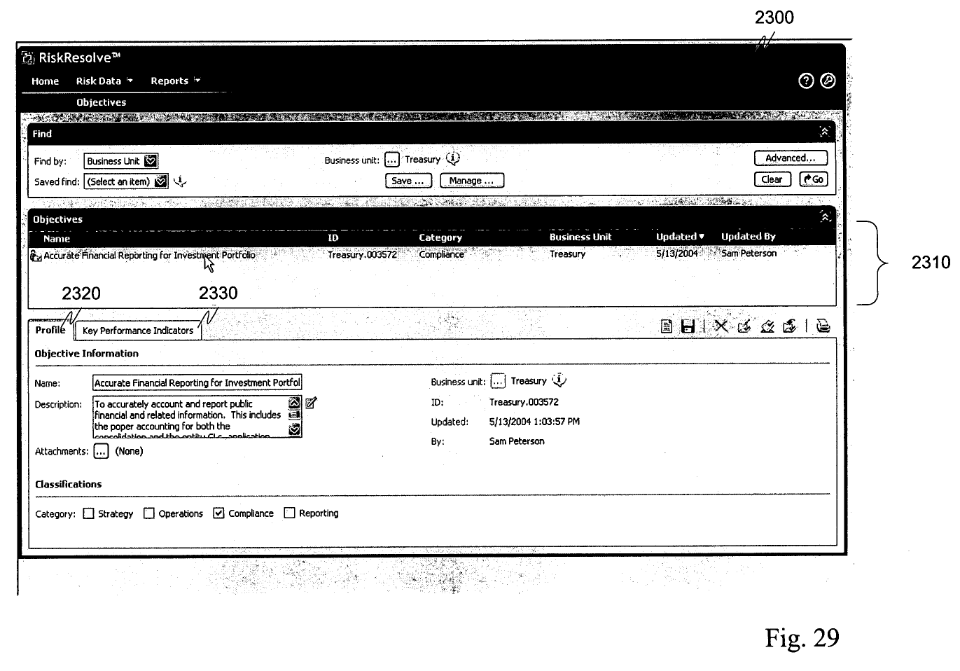

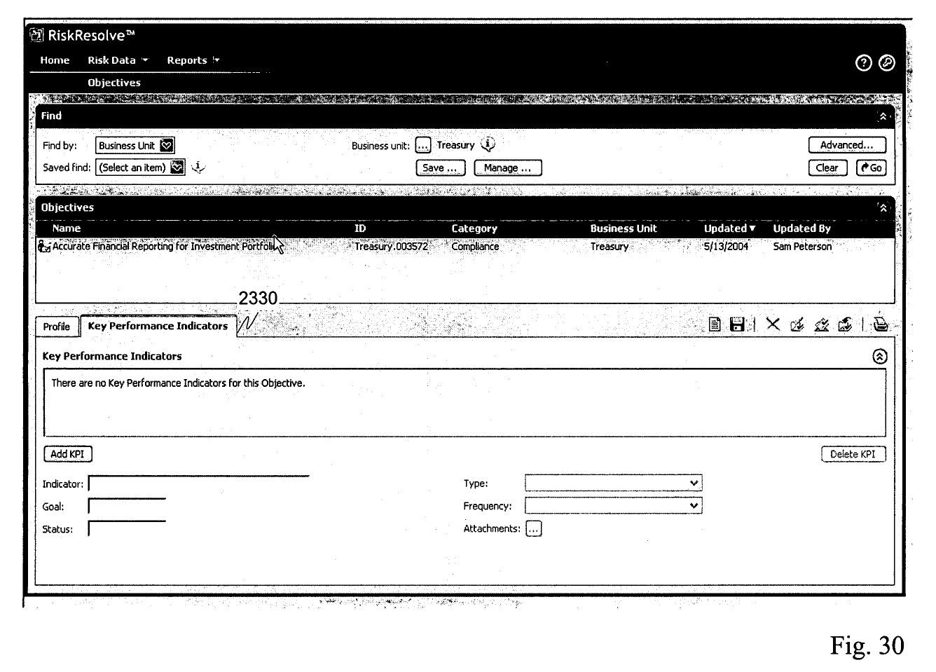

FIG. 29 illustrates the risk data objectives interface 2300. The risk data objectives interface 2300 includes a list of objectives 2310 as well as profile information 2320 and key performance indicator information 2330. Upon selection of the profile information 2320, objective information such as the name, description, business unit, identifier update information and author information can be displayed, as well as classification information. As illustrated in FIG. 30 upon selection of the key performance indicator tab 2330, key performance indicator(s) for the objective are illustrated, if any, as well as the ability to add and delete key performance indicators. Along with each key performance indicator, information such as the goals, status, type, frequency and any associated important attachments can be accessed and/or edited.

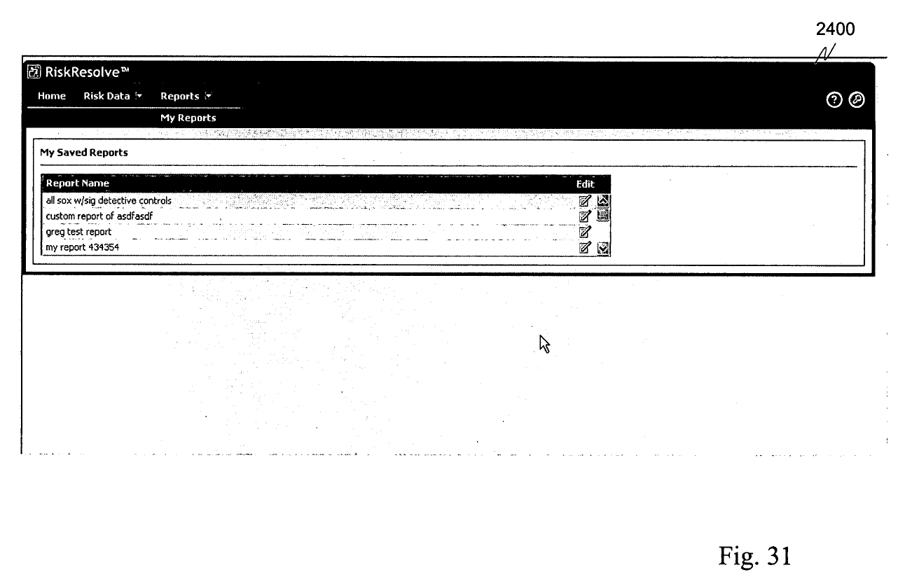

FIG. 31 illustrates an exemplary reports interface 2400. In particular, the reports interface 2400 is directed toward the “My Report” interface that displays the reports for a particular user. Specifically, a list of selectable reports 2410 is displayed, as well as the ability to edit the reports given to a user.

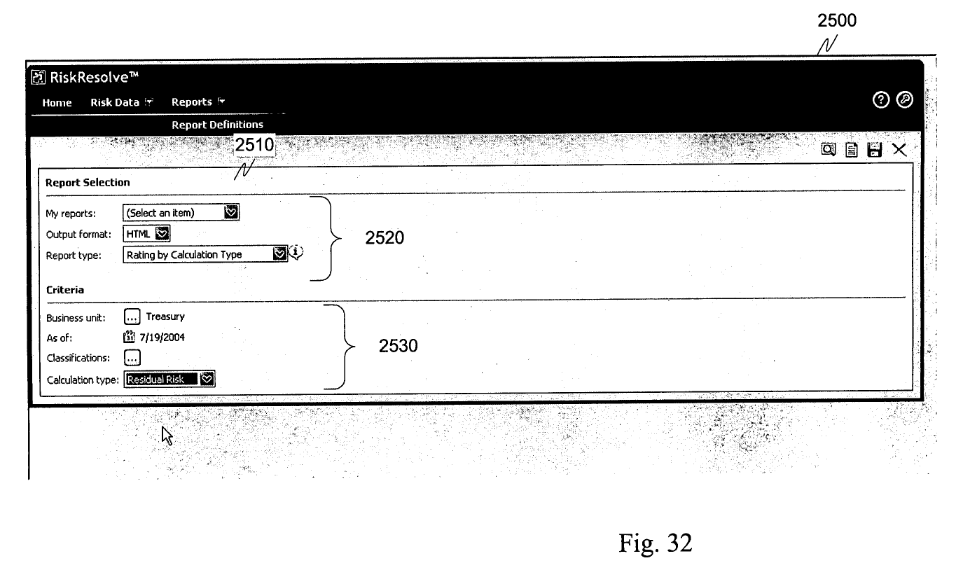

FIG. 32 illustrates a report definition interface 2500 that allows the defining of reports. In particular, a user can select a report in the report selection interface 2510 and then define such information as output format, report type, and the like, through the selection of, for example, pull-down menus 2520. Furthermore, selection criteria 2530 such as the business unit, as of date, classifications, and calculation type can also be selected through, for example, pull-down menus.

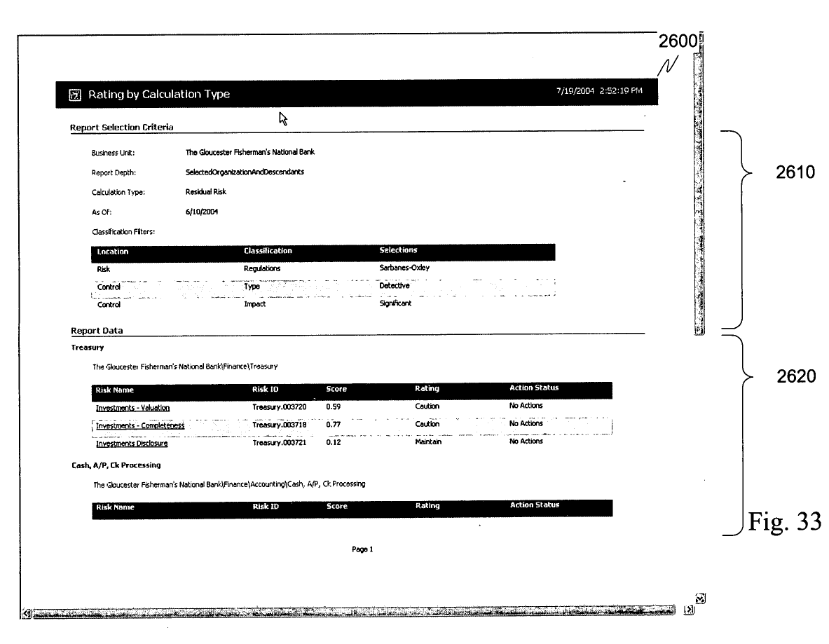

FIG. 33 illustrates an exemplary report selected by calculation type. In this report, the selection criteria 2610 are provided as well as the accompanying report data presented. This report can be electronic or hard copy, as well as dynamic thereby allowing a user to drill-down into additional information. Furthermore, this report can be in any electronic format including, but not limited to, HTML, a word processing document, a spreadsheet document, an e-mail, or the like.

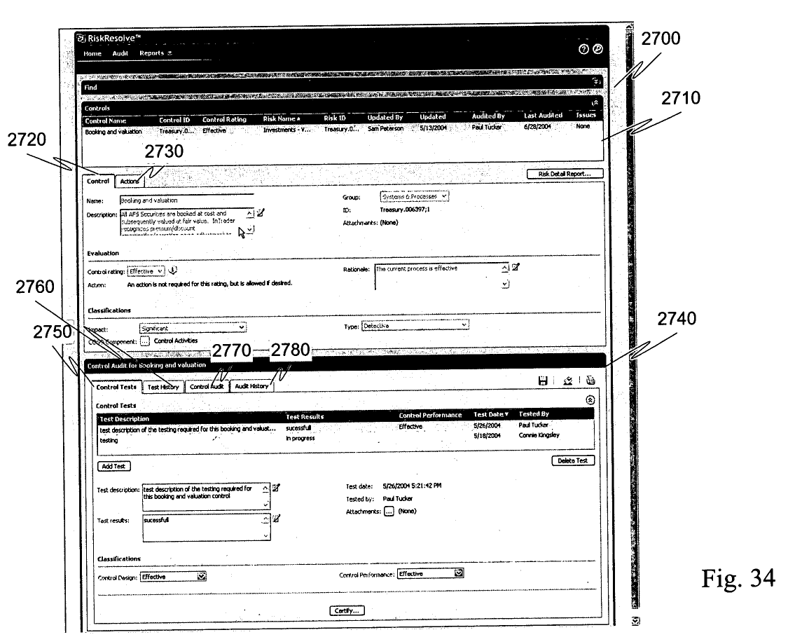

FIG. 34 illustrates an exemplary interface associated with the auditing system. In particular, audit interface 2700 list controls 2710 as well as specific information about the control in tab 2720 and related actions in 2730. Control tab 2720 displays such information as the name, description, group, identifier and attachments associated with the control, as well as the valuation and classification information. Furthermore, a control audit for booking and valuation portion 2740 provides tabbed information such as control tests, test history, control audit and audit history. Control test tab 2750 displays information such as control tests, as well as the ability to add and delete a test. Furthermore, information such as the test description, test results, test date and any associated attachments can be displayed. Furthermore, relevant classifications can be displayed and a certified button 2752 can be provided to allow the certification of the control audit.

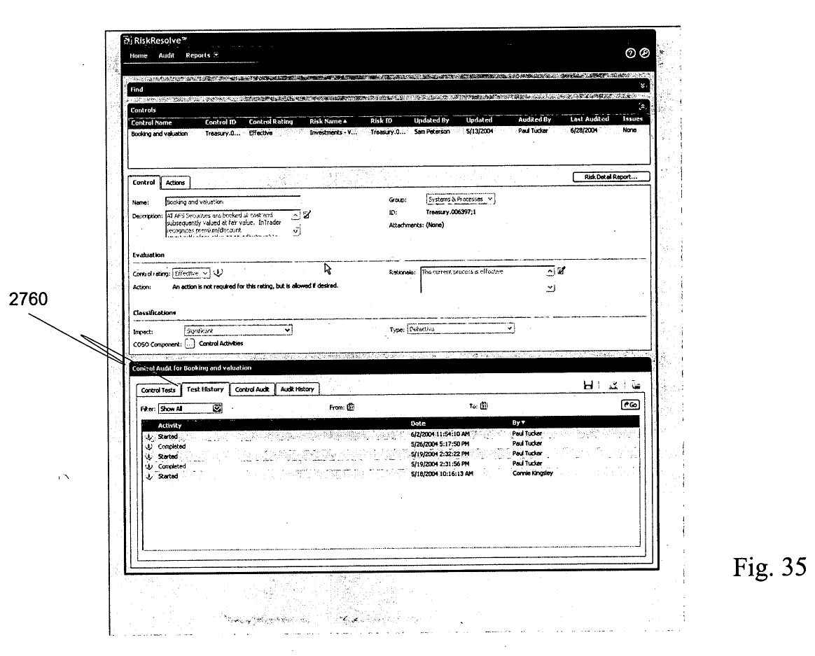

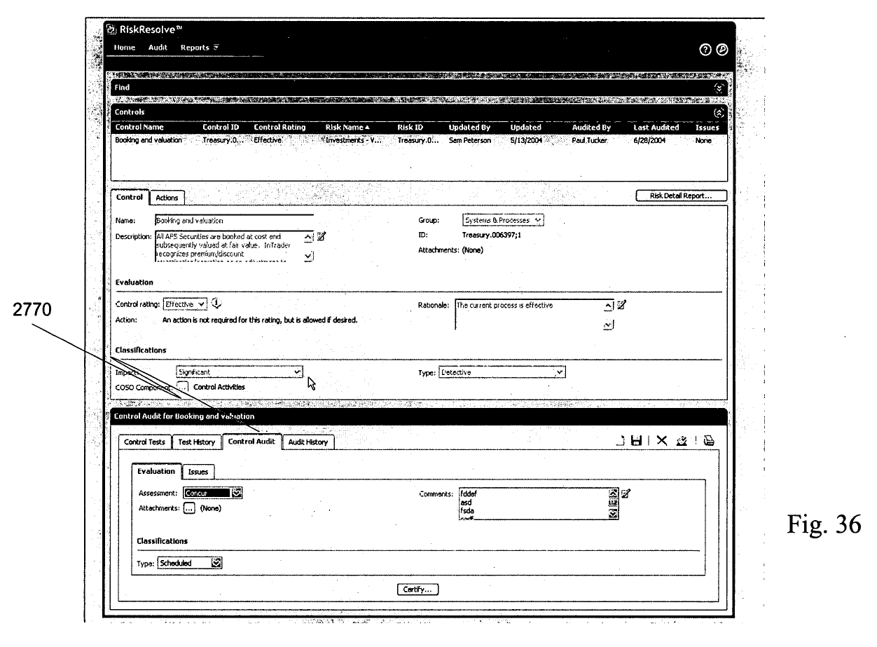

FIG. 35 illustrates in greater detail the test history portion 2760 of the audit interface. In particular, the test history tab 2760 displays filterable data relating to, for example, the activity, date of the activity and author within, for example, a particular date range.

The control audit interface 2770 provides evaluation and issues sub-tabs that allow for audit personnel to identify control “issues” that need to be addressed by business line managers to ensure that the control environment conforms with internal audit best practices and control theory. These issues are reportable, and traceable through the ultimate resolution date by the business unit manager, and within the inventive system comprise an audit trail and evidence of the dynamic nature of the institutions “control environment.”

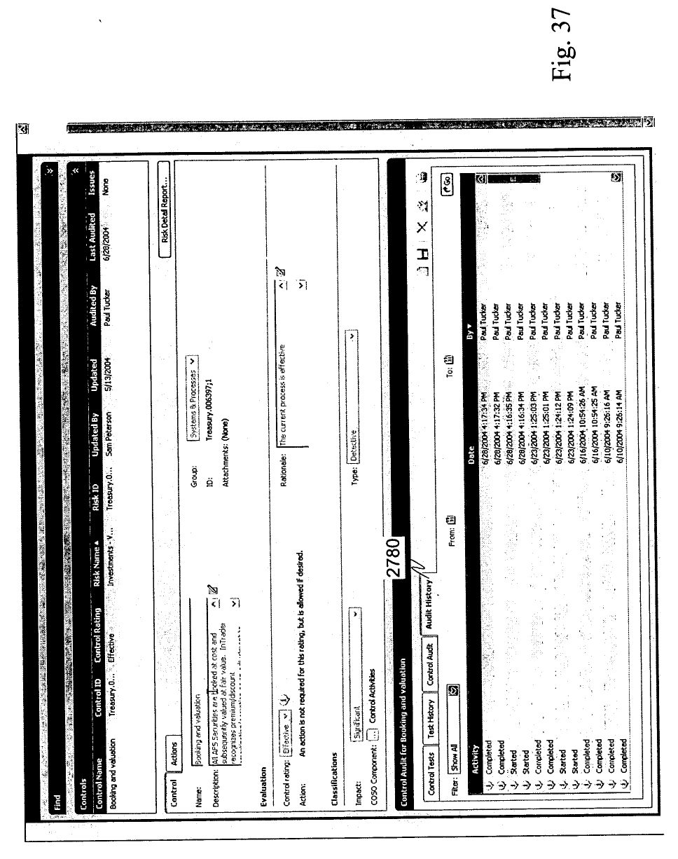

Finally, the audit history tab 2780 illustrated in FIG. 37 provides a filterable list of audit activities that can be, for example, drilled-down into for further information.

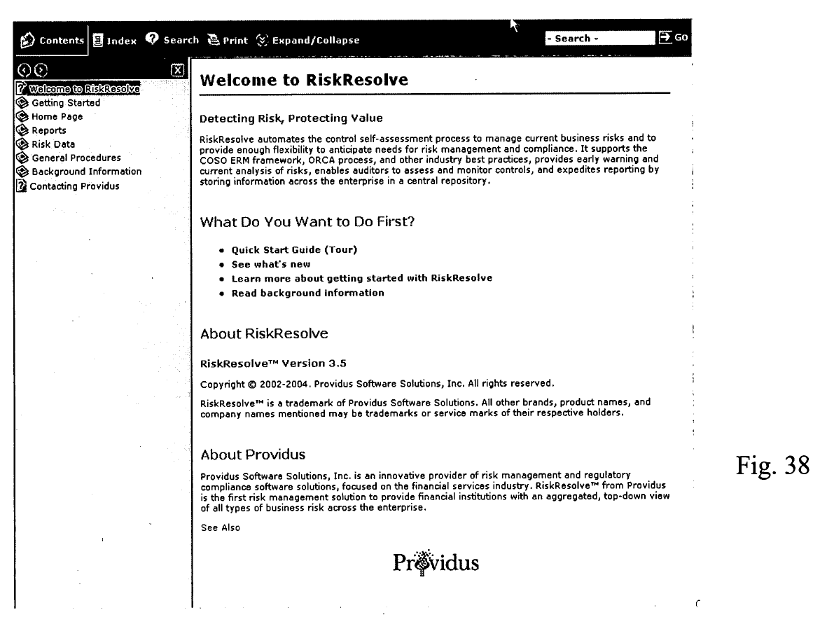

FIG. 38 illustrates a help screen that can provide users such information as getting started, how to run reports, how to enter risks, and the like.

The above-described systems and methods can be implemented on a computer server, personal computer, in a distributed processing environment, or the like, or on a separate programmed general purpose computer having database management and user interface capabilities. Additionally, the systems and methods of this invention can be implemented on a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, or the like, or a neural network and/or through the use of fuzzy logic. In general, any device capable of implementing a state machine that is in turn capable of implementing the flowcharts illustrated herein can be used to implement the invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or a VLSI design. Whether software or hardware is used to implement the systems in accordance with this invention is dependent on the speed and/or efficiency requirements of the system, the particular function, and the particular software or hardware systems or microprocessor or microcomputer systems being utilized. The systems and methods illustrated herein however can be readily implemented in hardware and/or software using any known or later developed systems or structures, devices and/or software by those of ordinary skill in the applicable art from the functional description provided herein and with a general basic knowledge of the computer and data processing arts.

Moreover, the disclosed methods may be readily implemented in software executed on programmed general purpose computer, a special purpose computer, a microprocessor, or the like. Thus, the systems and methods of this invention can be implemented as program embedded on personal computer such as JAVA® or CGI script, as a resource residing on a server or graphics workstation, as a routine embedded in a dedicated risk mitigation and management system, or the like. The system can also be implemented by physically incorporating the system and method into a software and/or hardware system, such as the hardware and software systems of a financial analysis suite.

It is, therefore, apparent that there has been provided, in accordance with the present invention, systems and methods for risk mitigation and management. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

1. A risk management and mitigation system comprising:
a risk data management module adapted to receive information associated with one or more risks;
a messaging module adapted to forward one or more messages to one or more users based on the information; and
a task module adapted to manage one or more actions associated with the one or more risks and one or more users, wherein the one or messages and the one or more actions provide a risk management framework.

2. The system of claim 1, further comprising a user module adapted to manage permissions associated with one or more users.

3. The system of claim 1, further comprising a roles module adapted to assign and manage one or more roles associated with one or more users, wherein the roles are associated with a branch of an organizational structure.

4. The system of claim 1, further comprising an organizational module adapted to receive and manage an organizational tree associated with an entity.

5. The system of claim 1, further comprising a subscriptions management module adapted to manage one or more subscriptions, the one or more subscriptions specifying one or more roles or one or more users that receive notifications upon the occurrence of an event.

6. The system of claim 5, wherein an event includes creation or modification of the information.

7. The system of claim 1, further comprising an administration module adapted to perform one or more of system management, message management, notice management, roles management, settings management, user administration and organization management.

8. The system of claim 1, wherein risk-defining classifications allow the one or more users to uniquely model compliance initiatives, risk assessment factors, and processes.

9. The system of claim 1, further comprising a user interface adapted to display risk information, task information and notice information.

10. The system of claim 9, wherein the one or more risks within the user interface can be sorted by business unit and risk type.

11. The system of claim 1, further comprising a risk profile interface adapted to display ratings and scores associated with the one or more risks.

12. The system of claim 11, wherein the ratings and scores can be one or more of graphically displayed, color coded, numerically represented and verbally summarized.

13. The system of claim 1, further comprising a document management module adapted to receive and associate one or more documents with the one or more risks.

14. The system of claim 1, wherein the one or more actions reflect corporate governance and risk management policies.

15. The system of claim 1, wherein controls are associated with the one or more actions and outline one or more of internal and external business processes related to compliance, people, systems and threats.

16. The system of claim 1, further comprising a loss event module adapted to track information related to one or more loss events.

17. The system of claim 1, further comprising a history module capable of preserving any changes that occur within the risk management and mitigation system.

18. The system of claim 1, wherein the one or more risks are associated with one or more objectives that relate to one or more of the areas of operations, regulations, strategy, governance and financial reporting.

19. The system of claim 1, wherein the one or more actions are assigned to an assignee, an assignee interface being updated to reflect the one or more assigned actions.

20. The system of claim 1, wherein the risk management and mitigation system is dynamically updated as the information associated with the one or more risks changes.

21. A risk management and mitigation method comprising:
receiving information associated with one or more risks;
forwarding one or more messages to one or more users based on the information; and
managing one or more actions associated with the one or more risks and one or more users, wherein the one or messages and the one or more actions provide a risk management framework.

22. The method of claim 21, further comprising managing permissions associated with one or more users.

23. The method of claim 21, further comprising assigning and managing one or more roles associated with one or more users, wherein the roles are associated with a branch of an organizational structure.

24. The method of claim 21, further comprising receiving and managing an organizational tree associated with an entity.

25. The method of claim 21, further comprising managing one or more subscriptions, the one or more subscriptions specifying one or more roles or one or more users that receive notifications upon the occurrence of an event.

26. The method of claim 25, wherein an event includes creation or modification of the information.

27. The method of claim 21, further comprising performing one or more of system management, message management, notice management, roles management, settings management, user administration and organization management.

28. The method of claim 21, wherein risk-defining classifications allow the one or more users to uniquely model compliance initiatives, risk assessment factors, and processes.

29. The method of claim 21, further comprising displaying risk information, task information and notice information.

30. The method of claim 29, wherein the one or more risks within the user interface can be sorted by business unit and risk type.

31. The method of claim 31, further comprising displaying ratings and scores associated with the one or more risks.

32. The method of claim 31, wherein the ratings and scores can be one or more of graphically displayed, color coded, numerically represented and verbally summarized.

33. The method of claim 21, further comprising receiving and associating one or more documents with the one or more risks.

34. The method of claim 21, wherein the one or more actions reflect corporate governance and risk management policies.

35. The method of claim 21, wherein controls are associated with the one or more actions and outline one or more of internal and external business processes related to compliance, people, systems and threats.

36. The method of claim 21, further comprising tracking information related to one or more loss events.

37. The method of claim 21, further comprising a history module capable of preserving any changes that occur within the risk management and mitigation system.

38. The method of claim 21, wherein the one or more risks are associated with one or more objectives that relate to one or more of the areas of operations, regulations, strategy, governance and financial reporting.

39. The method of claim 21, wherein the one or more actions are assigned to an assignee, an assignee interface being updated to reflect the one or more assigned actions.

40. The method of claim 21, further comprising dynamically updating the information associated with the one or more risks.

41. A risk management and mitigation system comprising:
means for receiving information associated with one or more risks;
means for forwarding one or more messages to one or more users based on the information; and
means for managing one or more actions associated with the one or more risks and one or more users, wherein the one or messages and the one or more actions provide a risk management framework.

42. An information storage media having information stored thereon to perform risk management and mitigation comprising:
information that receives information associated with one or more risks;
information that forwards one or more messages to one or more users based on the information; and
information that manages one or more actions associated with the one or more risks and one or more users, wherein the one or messages and the one or more actions provide a risk management framework.

43. A testing and auditing method comprising ensuring oversight, testing auditing and certifying of a control environment in an automated, secure and audit trailed fashion.
